(19) United States
(12) Patent Application Publication
(10) Pub. No.: US 2013/0030911 A1
(43) Pub. Date: Jan. 31, 2013

(54) PUBLIC INTERACTIVE PERSONALIZED RADIO NETWORK

(71) Applicant: Rabih Salem Ballout, Burlingame, CA (US)

(72) Inventor: Rabih Salem Ballout, Burlingame, CA (US)

(21) Appl. No.: 13/633,706

(22) Filed: Oct. 2, 2012

Related U.S. Application Data
(63) Continuation-in-part of application No. 12/689,183, filed on Jan. 18, 2010.
Application No. 12/689,183 is a continuation-in-part of application No. 12/689,193, filed on Jan. 18, 2010.
Application No. 12/689,193 is a continuation-in-part of application No. 12/689,200, filed on Jan. 18, 2010.

(30) Foreign Application Priority Data
Dec. 21, 2010 (US) PCT/US2010/061643

(51) Int. Cl. G06Q 30/02

(52) U.S. Cl. 705/14.49; 705/14.4; 705/14.69

(57) ABSTRACT

An interactive radio network enables users to interact with the content of a radio broadcast, including commercials or messages, and to selectively save, store, review, fast forward, rewind, pause, forward, and respond to the radio programs and/or the commercials. The interactive radio network provides a widespread, international, and economical access to the radio stations, and reduces the need for advertisement billboards. It provides the users with an opportunity to selectively inquire about the products or services being advertised. Furthermore, the interactive radio network allows the users as well as various sectors of the advertisement industry to interact with the content of the radio broadcast. The advertisements are no longer limited to audio messages, but can further include elaborate video, text, and data information. The interactive radio network enables the users to communicate and interact with each others, based on the broadcast content. It also provides a widely accessible and affordable avenue for mass marketing and broadcasting of commercials to mobile users.

### PRIORITY AND RELATED APPLICATION

The present application is a continuation-in-part of co-pending U.S. patent application Ser. Nos. 12/689,183; 12/689,193; and 12/689,200, all of which were concurrently filed on Jan. 18, 2010, all of which are incorporated herein by this reference.

The present application further relates to the patent application, titled “Public Interactive Personalized Radio Networking Method,” which is filed on even date herewith, which is incorporated herein by this reference.

### FIELD OF THE INVENTION

The present invention relates in general to the field of communications. More particularly, this invention relates to a system, method, and associated service for interactively providing a personalized network using telecommunications wavelength, such as radio wavelengths or other digital wavelengths that transmit digital signals. The present interactive radio network enables users, advertisers, and manufacturers to input visual radio advertisements or commercials, to interact with such commercials, and to selectively save, store, review, fast forward, rewind, forward, and respond to the radio programs and/or commercials. In addition, the present invention provides the listeners with the ability to selectively present further inquires about the products or services being advertised; the ability to purchase music items and programs directly from the individual broadcasting stations; and the ability to personalize the broadcasting programs.

### BACKGROUND OF THE INVENTION

Presently, the listeners to radio, such as satellite radio, AM radio, or FM radio, are passive users who are subjected to radio commercials with no ability for interaction and further without the ability to select the commercials of their choice for further review. Further, once a radio program or commercial has been broadcasted, it would no longer be possible for the listener to review the desired program or commercial using the conventional radio equipment.

Basically, prior to the advent of the present invention, the radio listeners are treated as passive users with no commercially viable alternative to interact with the content of the broadcast. The listeners are currently bound to accept the advertisements forced upon them, which advertisements are restricted to audio messages. In addition, the listeners are not provided with the ability to selectively present further inquires about the products or services being advertised; the ability to purchase songs and programs directly from the individual broadcasting stations; nor the ability to personalize the broadcasting programs.

Another means for reaching listeners includes the billboards that are dispersed along highways and on buildings. Such billboards are generally unsightly and could present a distraction to the passing drivers. In addition, billboards constitute a relatively expensive advertisement avenue that is not readily accessible to most users, manufacturers, broadcasters, advertisers, and marketers.

Furthermore, current radio equipment do not allow the listeners to communicate with each others on a user-to-user basis based on the broadcast content.

The foregoing and other concerns with the conventional radio broadcast system have heretofore remained unsolved. There remains an unsatisfied need for a system, method, and associated service for interactively providing a personalized network using the radio wavelengths.

### SUMMARY OF THE INVENTION

The present invention satisfies this need, and presents a system, method, network, and associated service (collectively referred to herein as “the invention”, “the present invention”, “the present system”, “interactive radio network”, “digital broadcasting for advertisement (DBA)”, or a similar designation) for interactively providing a personalized network using the radio wavelengths.

The present interactive radio network enables users to interact with the content of a radio broadcast, including commercials (advertisements) or messages, and to selectively save, store, review, fast forward, rewind, forward, and respond to the radio programs and/or the commercials. As used herein, the terms “user” or “users” encompass listeners, viewers, advertisers, manufacturers, or any person or system capable of manually or automatically inputting or receiving visual radio advertisements, commercials, messages, or programs (collectively referred to herein as “advertisements” or “ads”).

The present interactive radio network also provides a widespread, international, and economical access to the radio stations, and reduces the need for advertisement billboards. It provides the users with an opportunity to selectively inquire about the products or services being advertised. As an example, the users are now able to make detailed inquiries about the features and benefits of the advertised products or services, prior to making sales or purchase transactions.

Furthermore, the present interactive radio network allows the users as well as various sectors of the advertisement industry to interact with the content of the radio broadcast. The advertisements are no longer limited to audio messages, but can further include elaborate video, text, and data information.

In addition, the present interactive radio network enables the users to communicate and interact with each others, based on the broadcast content. It also provides a widely accessible and affordable avenue for mass marketing and broadcasting of commercials to mobile users, such as car drivers, airplane passengers, hikers, etc.

To this end, the present interactive radio network enables users to interact with the content of a radio broadcast, including commercials or messages, and to selectively save, store, review, fast forward, rewind, pause, forward, and respond to the radio programs and/or the commercials. The interactive radio network provides a widespread, international, and economical access to the radio stations, and reduces the need for advertisement billboards. It provides the users with an opportunity to selectively inquire about the products or services being advertised. Furthermore, the interactive radio network allows the users as well as various sectors of the advertisement industry to interact with the content of the radio broadcast. The advertisements are no longer limited to audio messages, but can further include elaborate video, text, and data information. The interactive radio network enables the users to communicate and interact with each others, based on the broadcast content. It also provides a widely accessible and affordable avenue for mass marketing and broadcasting of commercials to mobile users.

More specifically, the present invention describes a method of using a public interactive radio network for broadcasting a digital radio program to a plurality of user stations. The present method includes a server for receiving the digital broadcast radio program; the server further receiving at least one visual advertisement; the server concurrently rebroadcasting said at least one visual advertisement and the digital broadcast radio program directly to the plurality of user stations over digital radio airwaves; the plurality of user stations playing the digital radio program and displaying said at least one visual advertisement; in response to a user selection made on a user station, of any one or more of: the digital radio program and said at least one visual advertisement, the user station automatically communicating with the server over a secondary communication network that is separate from the digital radio airwaves, to transmit the user selection; and in further response to the user selection, the server retrieving additional data, and transmitting the additional data to the user station over the secondary communication network.

In response to the user selection, the user station can perform any one of more functions: saving, storing, deferred playing, deferred viewing, forwarding, reviewing, transferring, responding, fast forwarding, rewinding, retransmitting, routing, managing, downloading, processing, enabling an action in response to, and responding to any one or more of: said digital radio broadcast program and said at least one visual advertisement.

In one embodiment of the present method, at least some of the plurality of user stations include a record function for enabling a selective recording of any one or more of said selected at least one visual advertisement and the selected digital radio broadcast program, wherein said selective recording includes selectively recording any one of: the selected visual advertisement independently from the selected digital radio broadcast program; the selected digital radio broadcast program independently from the selected visual advertisement; and the selected visual advertisement concurrently with the selected digital radio broadcast program.

In another embodiment of the present method, at least some of the plurality of user stations include a playback function for enabling a selective playback of any of: the recorded visual advertisement and digital radio broadcast program. Alternatively, in the present method said at least some of the plurality of user stations include a scheduler function for programming a selective recording schedule of any of: the selected visual advertisement and digital radio broadcast program.

The present method may further selectively allow at least one advertiser to access the server, in order to place a digital coupon for selective transmission to at least some of the plurality of user stations.

The present method may display to an advertiser, a plurality of time slots that are available to the advertiser for the placement of any one or more of the digital coupon or the visual advertisement.

The present method may display to the advertiser, a plurality of parameters for further selection; wherein the plurality of parameters include any one or more of times, durations, lengths, and frequencies of the time slots that are available for the visual advertisement and the digital radio broadcast program to be concurrently broadcast within the available time slots.

In yet another embodiment, the present method may, upon selection of at least one parameter of the plurality of parameters for the available time slots, automatically calculate charges associated with the selection; and automatically forward the calculated charges to the advertiser.

The present method may selectively allow a marketer to access the server, in order to collect metadata related to the user selection; or it may automatically calculate charges associated with the metadata; and automatically forward the calculated charges to the marketer.

The present method may selectively allow a broadcasting station to access the server, in order to integrate a user selected visual advertisement with a user selected digital radio broadcast program, for rebroadcast to the plurality of user stations.

The present method may further allow the user station to forward a message to at least one other of said user stations, or it may allow the user station to forward any of said recorded at least one visual advertisement and broadcast program to at least one desired destination, wherein at least one desired destination includes any one or more of: a designated friend's destination; a phonebook; a favorite site; and a social site.

The present method may enable the user station to purchase any one of: the user selected visual advertisement and the user selected digital radio broadcast program, or it may enable the user station to download any one of: the user selected visual advertisement and the user selected digital radio broadcast program.

The present method may also enable the user station to selectively display any one of selected visual advertisement and the user selected digital radio broadcast program. The user station is able to select any one of: the user selected visual advertisement and the user selected digital radio broadcast program, includes setting search parameters.

The present method may enable the server to transmit the additional data to a user's mobile telephone.

In one embodiment of the present method, the user station tethers said at least one visual advertisement to a screen for display; or the user station tethers said digital radio broadcast program to a screen for display.

The secondary communication network of the present method may include an nG communication network; a mobile telephone network; a satellite telephone communication network; a WIFI communication network; an internet communication network; or an intranet communication network.

According to yet another embodiment, the present method recognizes one or a series of specific terms, words, flags, or tags being broadcast or communicated over the system, such as during a conversation or a broadcast program. The present method then uses these recognized specific terms to query a database of advertisements and commercials that are either stored on a plurality of clouds, servers, etc., or communicated on the Internet or similar networks, in order to generate or reproduce, and to present relevant commercials and advertisements to the user.

According to still another embodiment, the present method is not limited to the English language. Rather, the present method can translate the recognized specific terms into various languages, in order to broaden the query to multinational networks and databases, and to retrieve and to present to the user, a wider selection of international commercials and advertisements. The user has the option to select the international language (or languages) of choice.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which an interactive radio network may be used according to the present invention;

FIG. 2 is a schematic illustration of a digital broadcasting for advertisement (DBA) system forming part of the interactive radio network of FIG. 1, along with its operating environment;

FIG. 3 is a schematic illustration of an exemplary user station forming part of the interactive radio network of FIG. 1, along with its operating environment;

FIG. 4 is comprised of FIGS. 4A and 4B that represent a flowchart illustrating a method of operation of the interactive radio network of FIG. 1, for allowing advertisers to use the network;

FIG. 5 is comprised of FIGS. 5A, 5B, 5C, and 5D that represent exemplary screen shots prepared by a local DBA site of FIG. 2, for display on an advertiser's computer, further illustrating the method of operation of FIG. 4 for placing an advertisement or message by the advertiser on the interactive radio network of FIG. 1;

FIG. 6 is a flowchart illustrating a method of operation of the local DBA site of FIG. 2, for allowing marketers to use the interactive radio network;

FIG. 7 is an exemplary screen shot prepared by the local DBA site of FIG. 2, for display on a marketer's computer, further illustrating the method of operation of FIG. 6 for allowing the marketer to collect access data on the interactive radio network of FIG. 1;

FIG. 8 is comprised of FIGS. 8A and 8B that represent a flowchart illustrating a method of operation of the local DBA site of FIG. 2, for allowing broadcasters to use the network;

FIG. 9 is an exemplary screen shot prepared by the local DBA site of FIG. 2, for display on a broadcaster's computer, illustrating a program schedule for a broadcasting station with proper access to the interactive radio network of FIG. 1;

FIG. 10 is an exemplary screen shot that is compiled by the interactive radio network of FIG. 1, illustrating a compilation of the program schedules for the advertisements, programmings, and messages that have been placed by the various users, broadcasting stations, and advertisers;

FIG. 11 is comprised of FIGS. 11A, 11B, 11C, and 11D that represent a flowchart illustrating a method of operation of the local DBA site of FIG. 2, for allowing users to use the interactive radio network;

FIGS. 12 through 28 are exemplary screen shots prepared by the local DBA site of FIG. 2, for display on a user's computer or user station, further illustrating the method of operation of FIG. 11 for allowing the user to selectively access the advertisements that are broadcast on the interactive radio network of FIG. 1;

FIG. 29 is an exemplary screen shot prepared by prepared by the local DBA site of FIG. 2, to display various user stations for use with the present invention;

FIG. 30 is a front view of a stand alone arm clock/radio for use as a user station with the present invention;

FIGS. 31 and 32 are two exemplary side views of the stand alone arm clock/radio of FIG. 29;

FIG. 33 is a rear view of the stand alone arm clock/radio of FIG. 29;

FIG. 34 is a cutaway view of vehicle incorporating various exemplary user stations shown mounted at various locations within the vehicle;

FIG. 35 is an enlarged view of an exemplary user station mounted on a dashboard of the vehicle of FIG. 33;

FIG. 36 is a flow chart illustrating an additional plug-in, method of operation, or service of the local DBA site of FIG. 2, for enabling the interactive radio network to perform and to expand its query by recognizing specific terms being broadcast, and by querying multinational databases in different languages; and

FIG. 37 is a simplified schematic illustration of the digital broadcasting for advertisement (DBA) system of FIGS. 1, 2, and 3, that shows the communication between an exemplary user station and the local DBA site over a primary channel that contains the public digital public radio broadcast airwaves and a secondary, user-initiated private communications network.

### DETAILED DESCRIPTION OF PREFERRED EMBODIMENTS

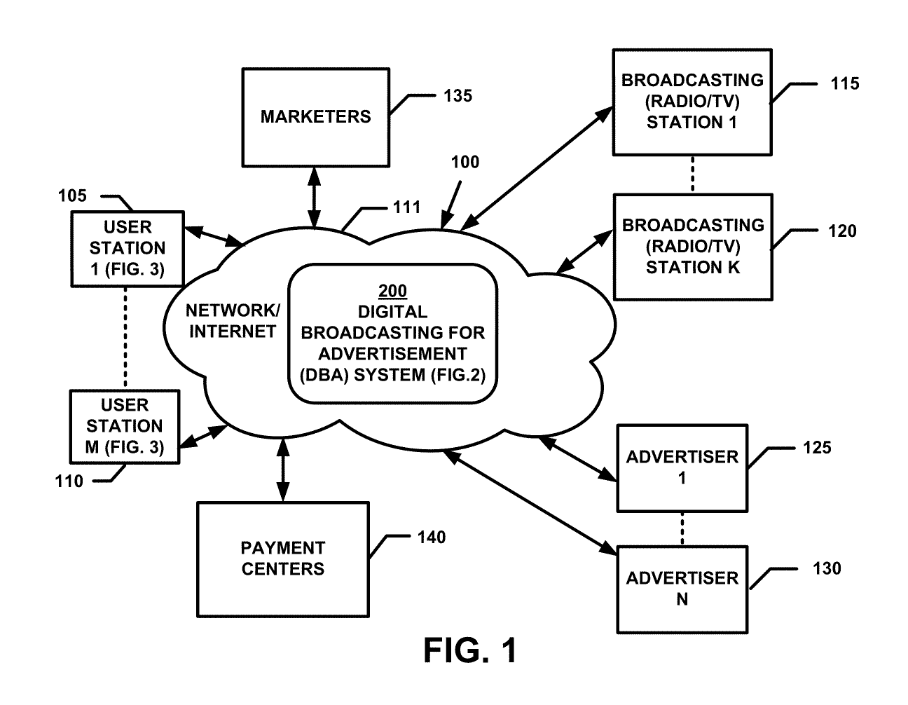

FIG. 1 illustrates an exemplary operating environment in which an interactive radio network 100 may be used according to the present invention. The interactive radio network 100 illustrates a plurality of representative user stations 105, 110 that communicate with a digital broadcasting for advertisement (DBA) system 200, via a network 111, as it will be described later in greater detail. The interactive radio network 100 selectively communicates with a plurality of broadcasting stations 115, 120, a plurality of advertisers 125, 130, a plurality of marketers 135, payment centers 140, and the user stations 105, 110, through the DBA system 200.

According to one embodiment of the present invention, a DBA system 200 is optionally capable of broadcasting, programming, and functioning as an independent radio broadcasting station (or broadcaster). As used herein, the term “radio” is not limited to radio broadcasting over the airwaves, but also includes other types or formats of radio broadcastings over various media, including but not limited to online or web radio broadcasting, satellite radio, or other similar media. In one embodiment, the DBA system 200 enables advertisers or other users to publish interactive, online video and audio advertisements on the interactive radio network 100. The radio network 100 may include, for example, standardized platforms, such as Genivi® or OnStar®. The DBA system 200 may utilize multiple networks such as the Internet, network clouds, wireless, satellites, cables, or any appropriate networks that are currently available or that may become available.

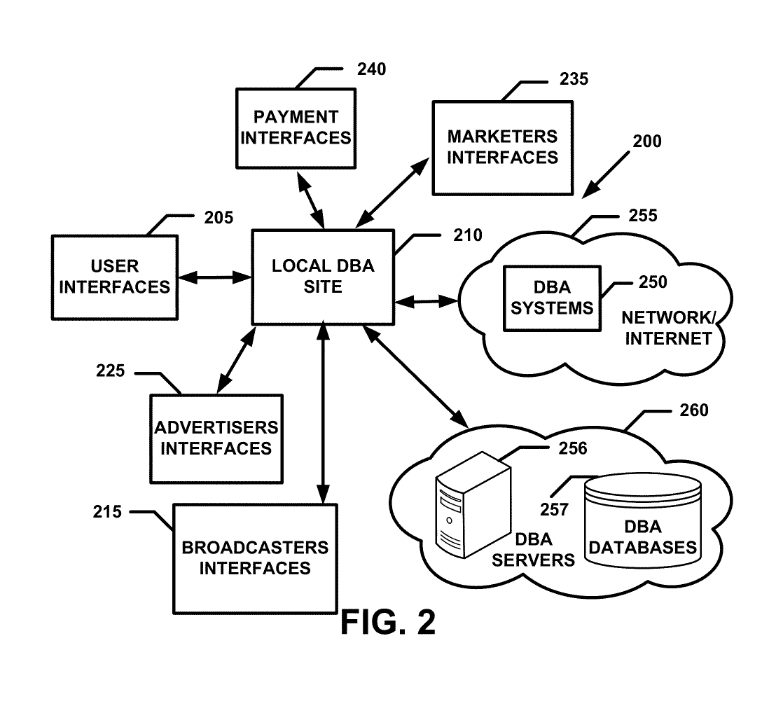

Referring now to FIG. 2, it illustrates the DBA system 200 forming part of the interactive radio network 100 of FIG. 1, along with its operating environment. More specifically, the DBA system 200 generally includes at least one local DBA site 210 that may be connected to other DBA systems 250 via a local, centralized, or decentralized network 255. The DBA system 200 further includes a plurality of local, centralized, or networked DBA servers 256 and databases 257 that are interconnected via a network 260.

The DBA system 200 also includes a plurality of interfaces that enable access to the local DBA site 210. As used herein, the term “interface” includes a hardware, a software, and/or a computer program product that is typically embedded within or installed on a computer, a server, or otherwise a dedicated auxiliary device. Alternatively, the interface can be saved on a removable storage medium such as a diskette, a CD, a DVD, a hard drive, or another known or available memory device.

As used herein, the scope of the following terms includes but is not limited to the following definitions:

“Broadcasting for advertisement, DBA system” includes without limitation a system for broadcasting digital advertisements.

“Digital broadcasting for advertisement (DBA)” as explained earlier, includes without limitation, a similar designation for interactively providing a personalized network using the radio wavelengths. These radio wavelengths digital broadcast signals (referenced later by the numeral 360), include digital airwaves and analogue broadcast signals that are digitized by means of an analogue-to-digital converter.

“Interconnecting” can be interpreted to mean mutually connecting.

“Connecting” can be interpreted to mean forming a social, professional, commercial, or any a relationship.

“Marketer” includes without limitation one who promotes, sells, or otherwise displays a product or service.

“nG” includes without limitation, a standard or protocol that complies with, for example the 3G, 4G, or a future similar standard, in reference to a wireless network. It should be clear that the use of the term “nG” does not necessarily limit the scope of the present invention to the G-protocol. Rather, this term is used herein as an illustration of an existing standard, such as the 3G and 4G protocols, and extends to other standards and protocols that are, or will be made available in the future.

“Payment center” includes without limitation a system involved in processing payments or revenues.

“Subscribing” can be interpreted to mean to assent to, to register with, or otherwise to become a member of a product or service.

“Tethering . . . to a screen” can be interpreted to mean displaying on a screen, or otherwise connecting or linking to a screen.

In the preferred embodiment illustrated in FIG. 2, the DBA system 200 includes a plurality of representative user station interfaces 205 that enable the user stations 105, 110 to access the local DBA site 210; a plurality of broadcasters' interfaces 215 that enable the broadcasters (or broadcasting stations) 115, 120 to access the local DBA site 210; a plurality of advertisers' interfaces 225 that enable the advertisers 125 to access the local DBA site 210; a plurality of marketers' interfaces 235 that enable the marketers 135 to access the local DBA site 210; and a plurality of payment interfaces 240 that enable access to the payment centers 140, either directly or through the local DBA site 210.

The metadata collected by the DBA system 200 will be stored in the dabatases 257, and will be selectively searchable by advertisers, marketers, DBA administrators, vendors, and other users of the DBA system 200, in order to enable data analysis. The metadata may include, for example: the number of unique visitors, the number of the total visits to web sites or stations, the identification of the pages or sites where a commercial transaction is consummated, etc. The DBA system 200 also allows monitoring user engagement metrics, such as the length and depth of each visit to the sites, identification of the geographical locations of the visitors, the mobile operators and devices used to access the advertisements, and the collection of similar metadata. The DBA system 200 further allows keyword search of data, referrals from other sites, direct traffic to mobile sites, and similar data. The DBA system 200 also allows the monitoring of performance and usage of individual pages on mobile sites, the monitoring of pages or sites to which the visitors are redirected upon accessing a particular advertisement site, and the determination of the pages with the highest exit rates, thus allowing vendors to measure a specific goal such as a campaign drive.

The DBA system 200 allows target advertisements to specific target markets based on demographics. As a result, advertisers, marketers, vendors, and various users of the DBA system 200 can further target their advertisements based on the following marketing criteria:

Behavioral: Behavioral Targeting Index converts online behaviors into actionable data for advertisers by scoring each online consumer's interest and purchase intent based on their recent online behavioral patterns.
Contextual: Dynamic segmentation of web content into more than thousands of categories, assigning a real-time Content Relevancy Score that ensures advertisers' ads are highly relevant to the immediate content.
Geographic: Enabling marketers to target consumers by geographic locations and customize messaging for optimal relevance.
Retargeting: Enabling advertisers to target their past website visitors or retarget consumers who have previously seen their ads in category placements outside of GD network.

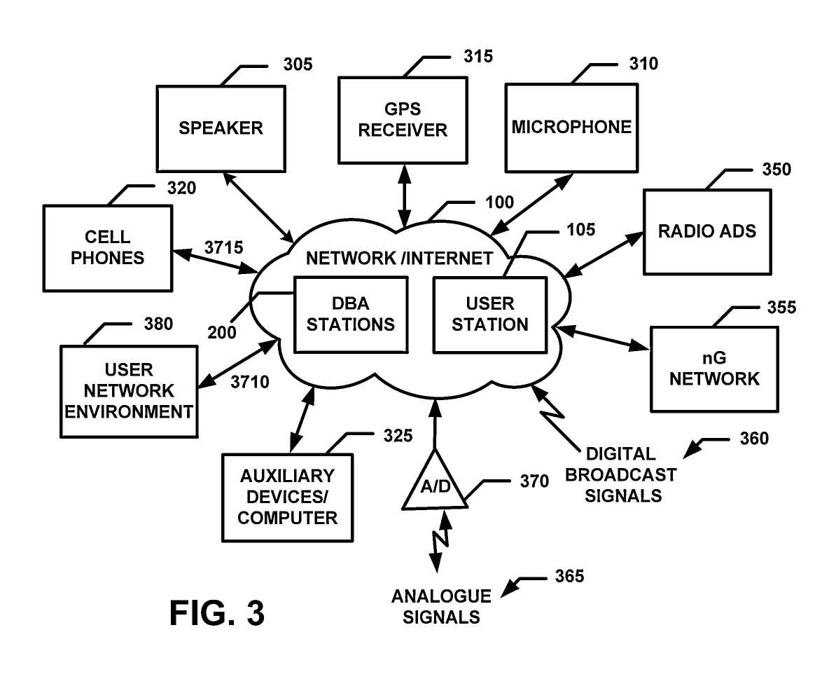

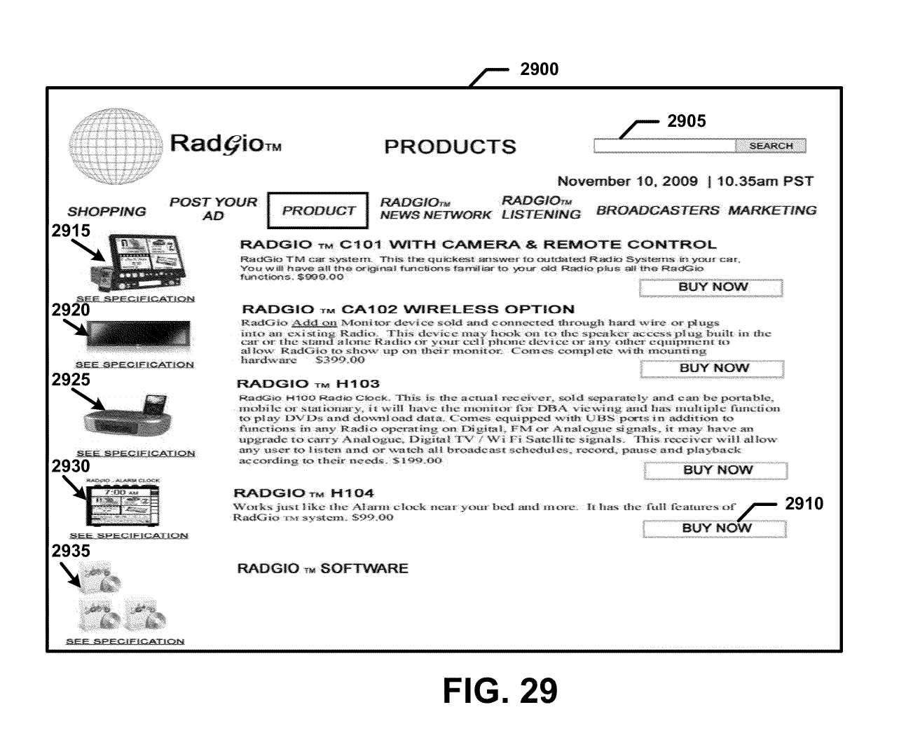

FIG. 3 is a schematic illustration of the exemplary user station 105 of the interactive radio network 100 of FIG. 1, along with its operating environment. As explained earlier, the user station 105 communicates with the DBA system 100 via the network 100. The user station 105 can be a standalone device as illustrated in FIG. 29, or it can be used with other auxiliary devices, such as an external speaker 305, a microphone 310, a GPS receiver 315, a cellular phone 320, or any other available compatible device 325. The user station 105 may also receive radio 350 and various other signals, including video, audio, and/or data signals over an nG communication network (e.g., 3G, 4G) 355, digital broadcast signals 360, or analogue broadcast signals 365 that are digitized by means of an analogue-to-digital converter 370.

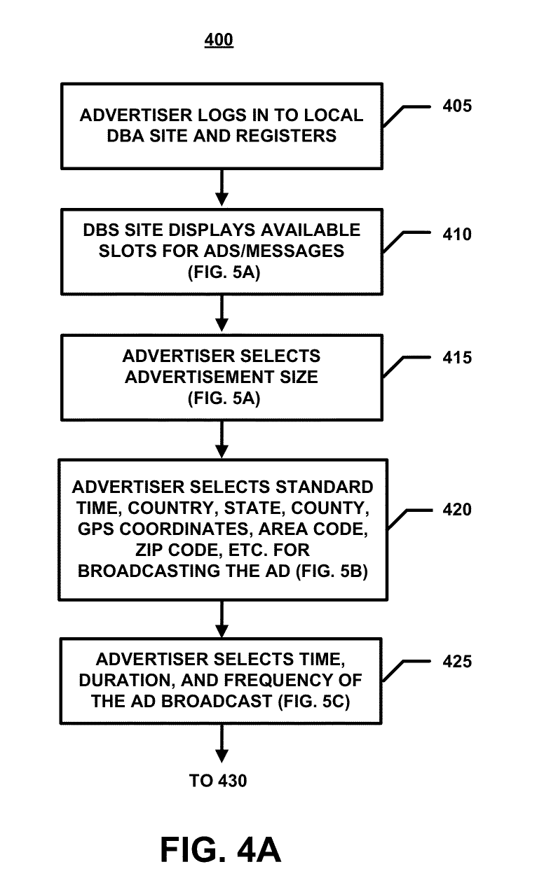

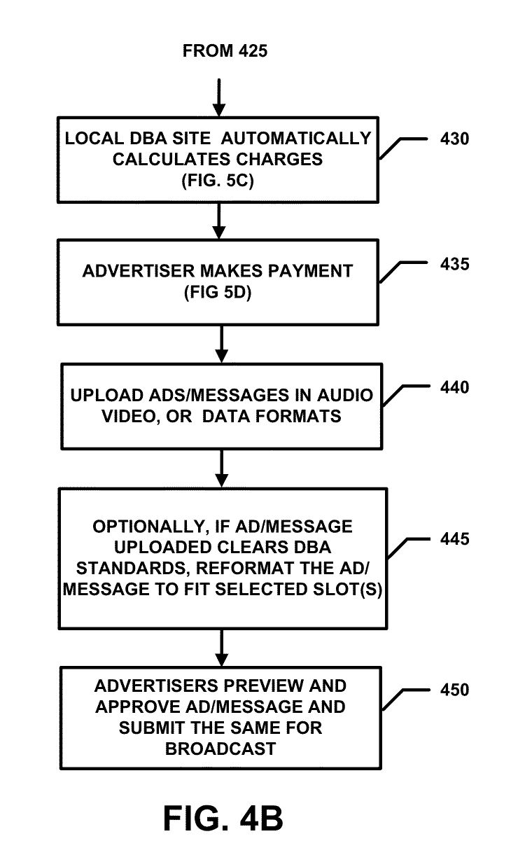

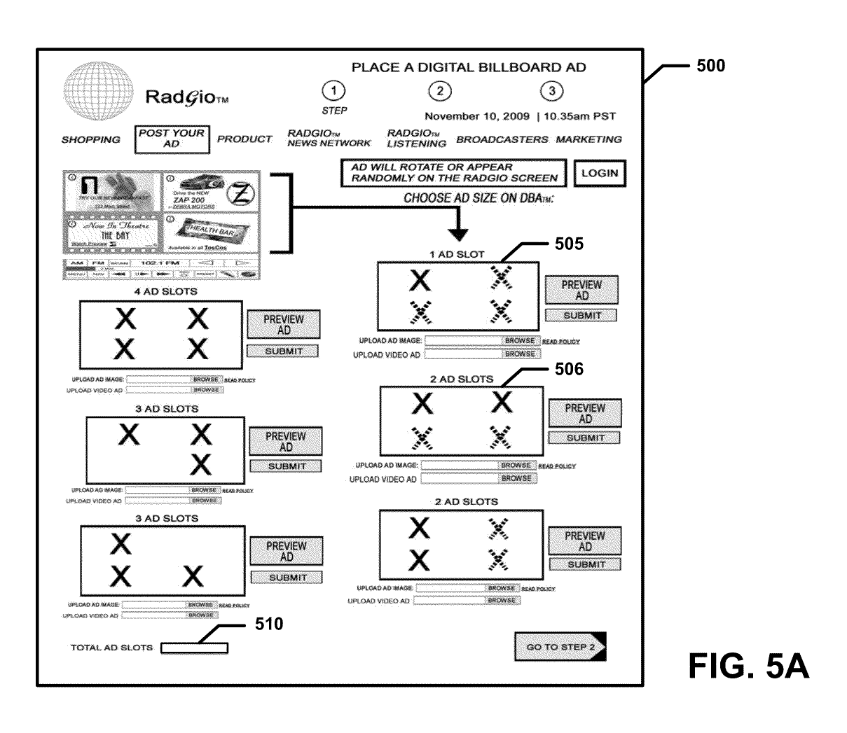

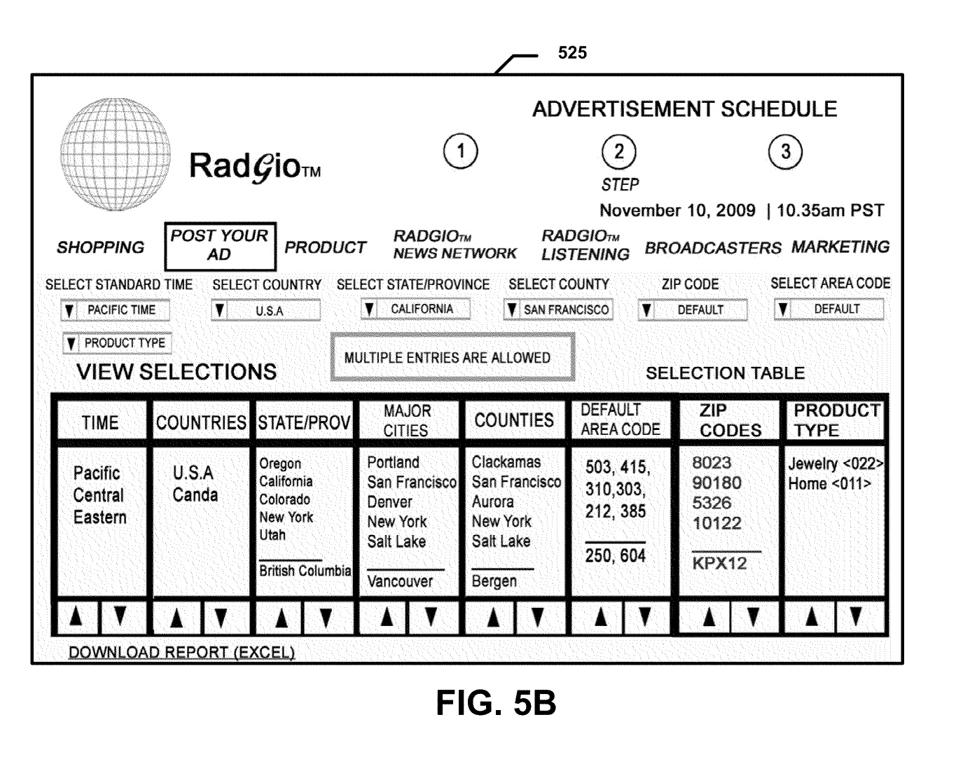

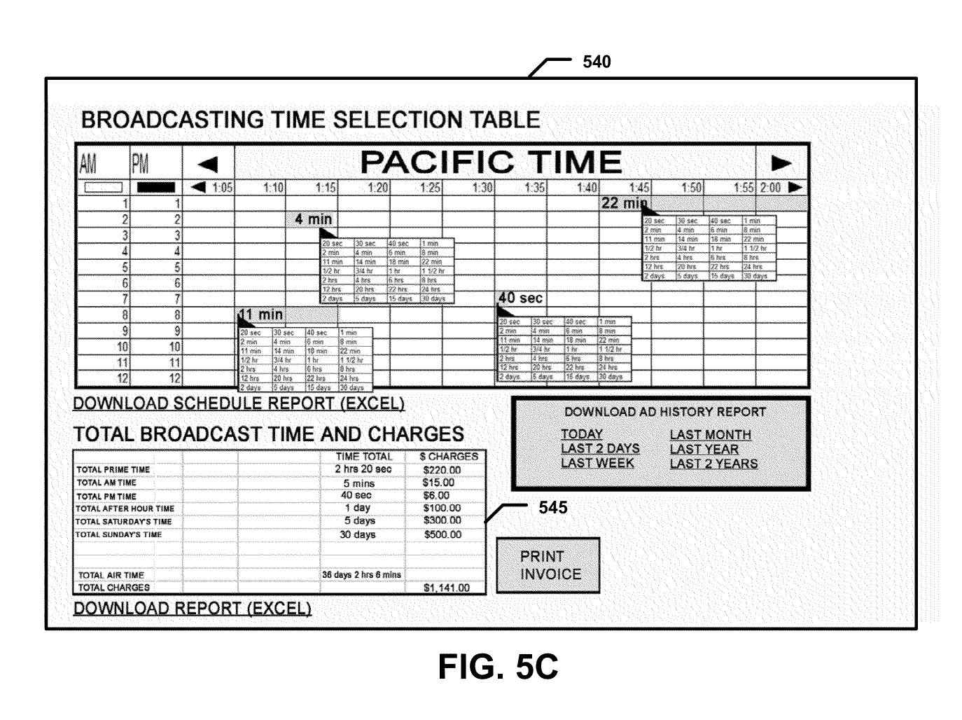

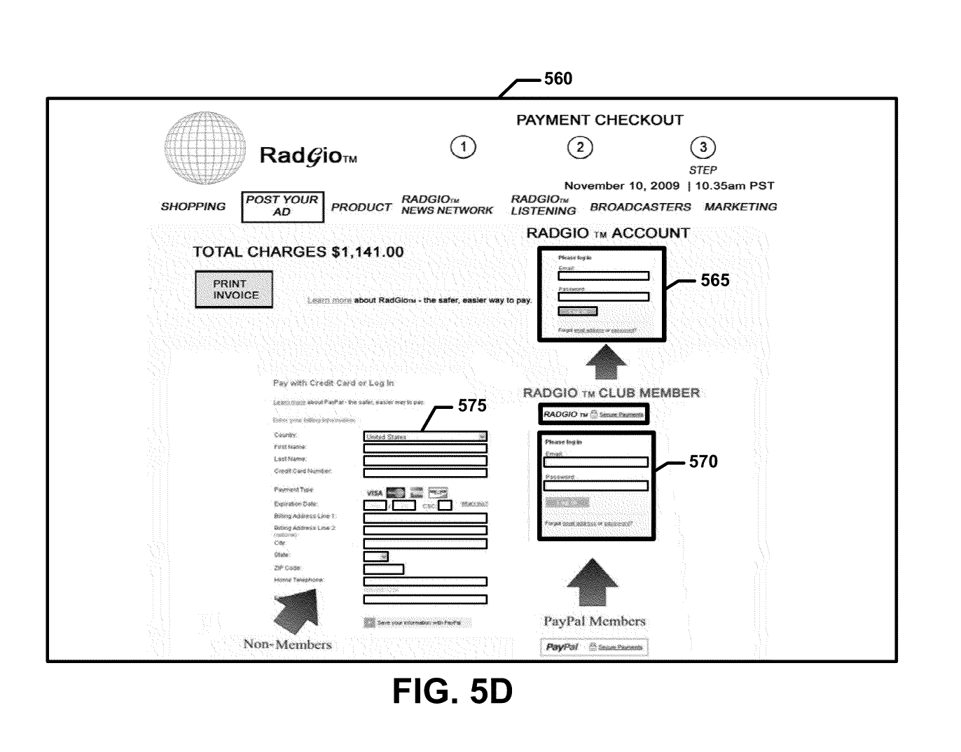

FIG. 4 includes FIGS. 4A and 4B and illustrates a method of operation 400 of the interactive radio network 100 of FIG. 1, for allowing the advertiser 125 to access and use the network 100. FIG. 5 includes FIGS. 5A, 5B, 5C, and 5D, and illustrates a plurality of screen shots 500, 525, 540, 560 that are prepared by the local DBA site 210, for display on an advertiser's computer. FIG. 5 further illustrates the method of operation 400 of FIG. 4, in order to enable the advertiser 125 to place at least one or more advertisements on the interactive radio network 100 of FIG. 1.

Considering now FIGS. 4 and 5 in combination, the advertiser 125 starts at step 405 by logging in to the local DBA site 210 to perform the initial registration or to place the desired advertisements to be broadcast to the user stations 105, 205. At step 410, in response to a proper login, and as illustrated in FIG. 5A, the local DBA site 210 displays the slots, e.g., 505, 506, that are available for the advertiser 125 to place the advertisements.

Each of the slots 505, 506 represents a predetermined time period, measured for example, in seconds. As an example, slot 505 shows that only a single slot out of 4 slots, is currently available for this advertiser. The available time period is illustrated by a solid X, while the unavailable time periods are illustrated by dashed X's. Alternatively, the X's could be used to predetermine the selected size of the advertisement rather than its availability; the presumption being that there will always be a few seconds for the advertisement to appear.

In addition, slot 505 shows that a predetermined number of advertisements could be displayed concurrently on the user station 105. In this particular example, slot 505 shows the placement of four concurrent advertisements, as illustrated by the locations of the X's. Such an arrangement provides the advertiser 125 with the flexibility of selecting both the duration of the advertisements and the arrangements of the advertisements, in preselected time increments.

The running total of the selected slots will be automatically calculated and displayed to the advertiser 125, in slot 510.

Referring now to step 420 of FIG. 4 and to the screen shot 525 of FIG. 5B, the advertiser 125 proceeds by selecting additional parameters of the advertisement broadcast. Such parameters include, for example, the standard time, country, state, province, county, zip code, area code, GPS coordinates, or any additional geographical boundaries of the broadcast.

At step 425 of FIG. 4 and its corresponding screen shot 540 of FIG. 5C, the advertiser 125 selects the times, durations, lengths, and frequencies of the advertisements to be broadcast. The broadcasting time selection table shown in the screen shot 540 provides the advertiser 125 with a very accurate means for selecting the desired parameters for the advertisement, in increments of, for example, 10 seconds.

At step 430 of FIG. 4, the local DBA site 210 automatically calculates the total charges for the advertisement selections, and displays these charges in detail, in a table 545, within the screen shot 540. The advertiser 125 has the option to make any desired modification to the selected parameters in order to achieve the advertiser's satisfaction with the charges.

At step 435 of FIG. 4 and its corresponding screen shot 560 of FIG. 5D, the advertiser 125 makes the payment for the charges calculated in table 545. Such payments may be made either directly to the local DBA site 210 using advertiser's account 565, or by using third party payment centers 140 (FIG. 1), via, for example, the payment interface 240 (FIG. 2) that are referenced by the numerals 570, 575 in the screen shot 560.

Once the payment is confirmed or received by the local DBA site 210, the advertiser 125 is prompted by the local DBA site 210 to upload the desired advertisements to be broadcast. At step 440 of FIG. 4B, the advertiser 125 uploads the desired audio, data, and/or video formats, whether in digital or analogue form (to be converted by the local DBA site 210). Optionally, and as allowed by the local laws, the local DBA site 210 performs, at step 445, the necessary review of the content of the uploaded advertisements, to ensure the appropriateness of such advertisements. Once the uploaded advertisements clear the set standardized scrutiny of the local DBA site 210, the latter can format and convert the cleared advertisements, as needed to best fit the slots that have been previously selected using screen shots 500, 525 and 540 of FIG. 5.

At step 450 of FIG. 4B, the advertiser 125 previews and approves the rendering of advertisements and submits the same to the local DBA site 210 for broadcast. If the rendered advertisements are not approved by the advertiser 125, additional revisions and renderings may be made by the advertiser 125 and/or the local DBA site 210 to ensure the advertiser's satisfaction and final approval of the advertisements.

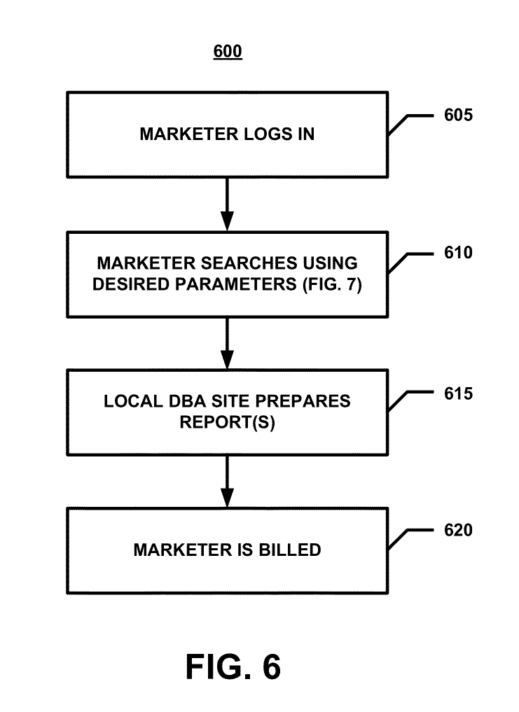

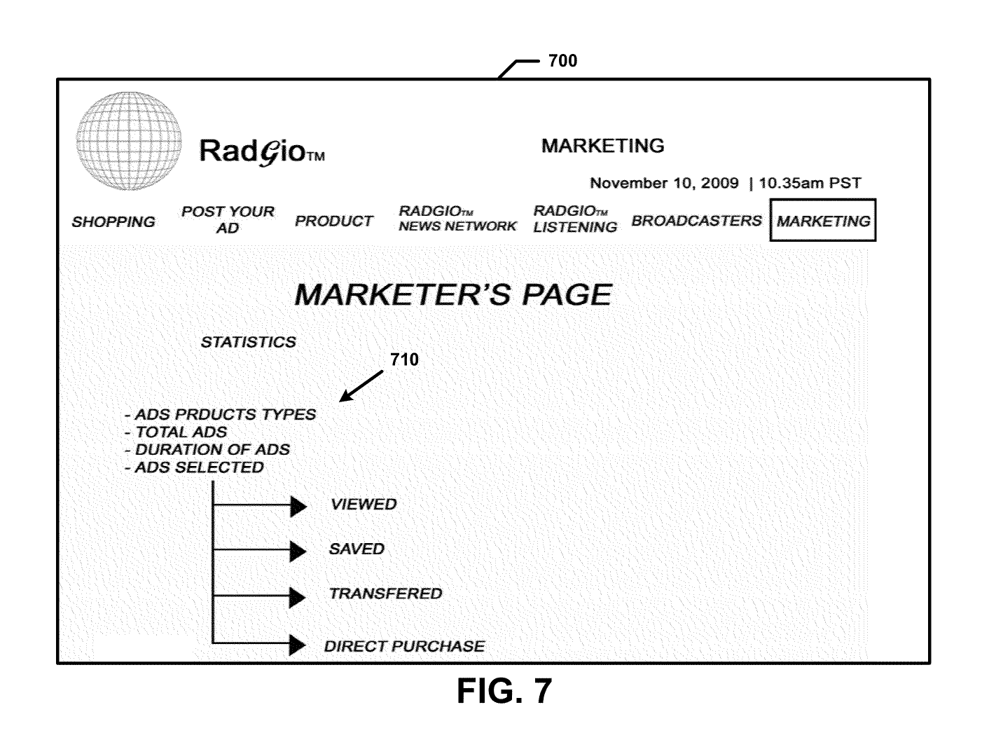

FIG. 6 is a flowchart illustrating a method of operation 600 of the interactive radio network 100 of FIG. 1, for allowing a marketer 135 to use the network 100. FIG. 7 illustrates an exemplary screen shot 700 which is prepared by the local DBA site 210, for display on a marketer's computer. Considering now FIGS. 6 and 7 in combination, the marketer 135 starts at step 605 by logging in to the local DBA site 210 to perform the initial registration or to access the marketer's already created account.

At step 610, in response to a proper login by the marketer 135, and as illustrated in FIG. 7, the local DBA site 210 displays the parameters 710 that are available to the marketer 135 to conduct a search and to collect the desired data. As an example, some of the parameters 710 include the types (kinds or categories) of the products that have been (or will be) advertised; the total number of these advertisements; the durations of these advertisements; and the advertisements that were selected, saved (or stored), transferred, or responded to (such as by a direct purchases) by the user stations 105, 110. At step 610, the marketer 135 searches the data collected by the local DBA site 210 and stored in the DBA databases 257 (FIG. 2), using the displayed parameters.

At step 615, and in response to the inquiry inputted by the marketer 135, the local DBA site 210 applies the search parameters to the data in the DBA databases 257 and automatically prepares a report to be communicated to the marketer 135. At step 620, the local DBA site 210 automatically prepares a statement and bills the marketer 135 for the search and the resulting report.

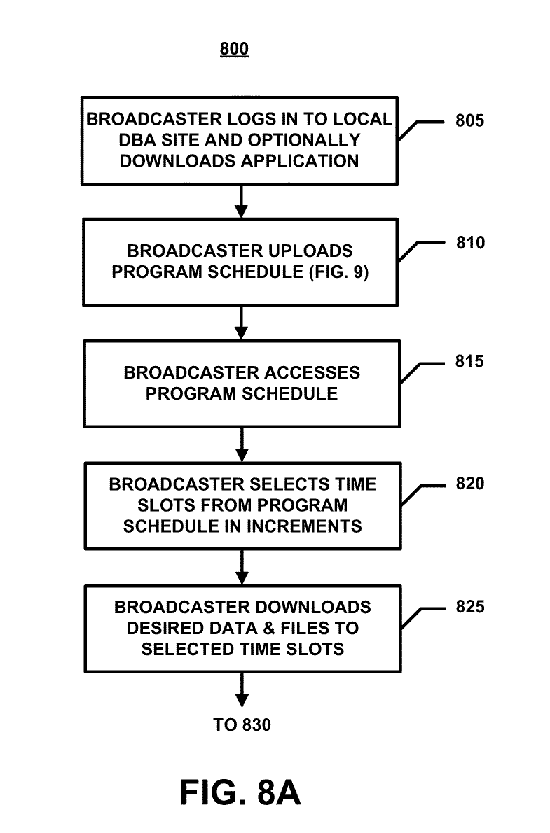

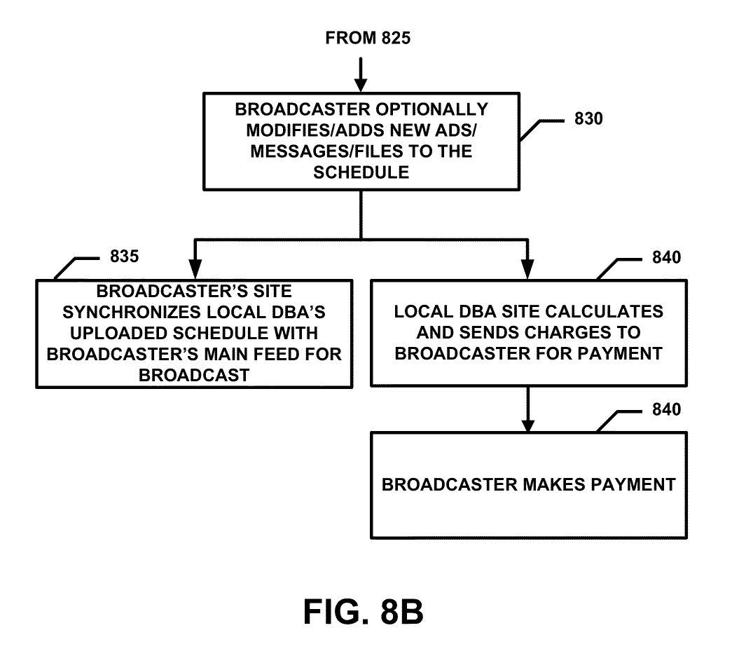

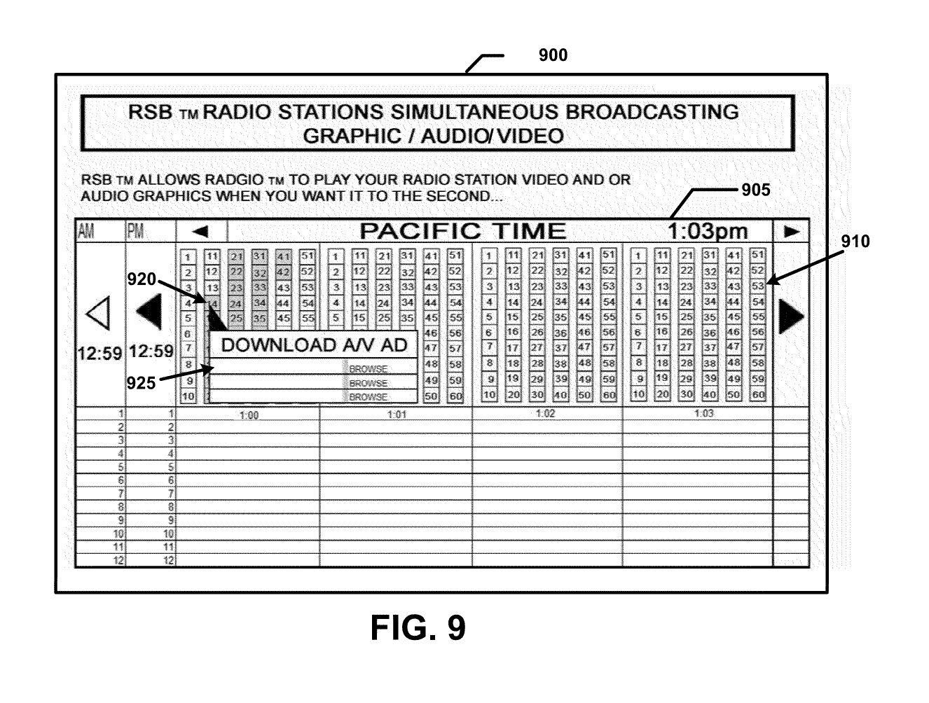

Referring now to FIG. 8 and its corresponding FIGS. 9 and 10, FIG. 8 (FIGS. 8A and 8B) illustrates a method of operation 800 of the interactive radio network 100 of FIG. 1, for allowing the broadcasting stations 115, 120 to access and use the network 100. FIG. 9 is an exemplary screen shot 900 that is prepared by the local DBA site 210 of FIG. 2, for display on a broadcaster's computer, illustrating a program schedule for the broadcasting station (or broadcaster), e.g., 115 with proper access to the interactive radio network 100.

The broadcasting station (or broadcaster), e.g., 115 logs in to the local DBA site 210 and optionally downloads an application from the local DBA site 210, that enables access to the interactive radio network 100. Alternatively, if the broadcasting station 115 is already registered with the local DBA site 210, then the broadcasting station 115 would login to the already established account.

At step 805 of method 800, the broadcasting station 115 uploads the program schedule 905 of FIG. 9. The program schedule 905 provides the broadcasting station 115 with accurate and detailed information on the scheduled advertisements, messages, programs, and other information to be broadcast on this broadcaster's broadcasting station.

The program schedule 905 illustrates a plurality of tabulated slots 910, each of which represents a predetermined period of time (e.g., 1 second), or a block of time intervals. In order for the broadcasting station 115 to review the content of a specific time slot 920, the broadcaster 115 accesses the program schedule at 815 and double clicks the specific time slot 920, in order to view the content that is allocated for broadcasting.

In the program schedule 815, the time slots 910 that are not devoid of content are visually highlighted in order to provide advance notice to the broadcaster 115 so that the empty time slots 920 are filled in order to avoid a disruption of the broadcast. As an example, if a specific time slot 920 is highlighted, the broadcaster 15 selects that time slot 920 and a pull down menu 925 appears. At step 825, the broadcaster 115 downloads the desired data and files to the selected time slot or interval 920.

At step 830, the broadcaster optionally modifies, adds, or deletes the content of the program schedule 900. The local DBA site 210 automatically formats the downloaded data and files to the proper format for broadcasting to the user stations 105, 110.

At step 835, the broadcaster's site automatically synchronizes the local DBA site's 210 uploaded program schedule 900 with the broadcaster's main feed for broadcast (or rebroadcast) as a rebroadcast stream. In other terms, the local DBA site 210 intercepts (i.e., captures or accesses) the broadcaster's broadcast over the digital airwaves, and uploads (or inserts) the appropriate commercials and advertisements in synchrony with the allotted time slots for these commercials and advertisements into the ongoing or scheduled broadcast, and then re-broadcasts the synchronized stream over the digital airwaves.

Concurrently, at step 840, the local DBA site 210 calculates the charges incurred by the broadcasting station 115 for the use of the interactive radio network 100, and automatically sends a corresponding invoice to the broadcasting station 115 for payment. At step 845, the broadcasting station 115 makes the payment using the payment centers 140.

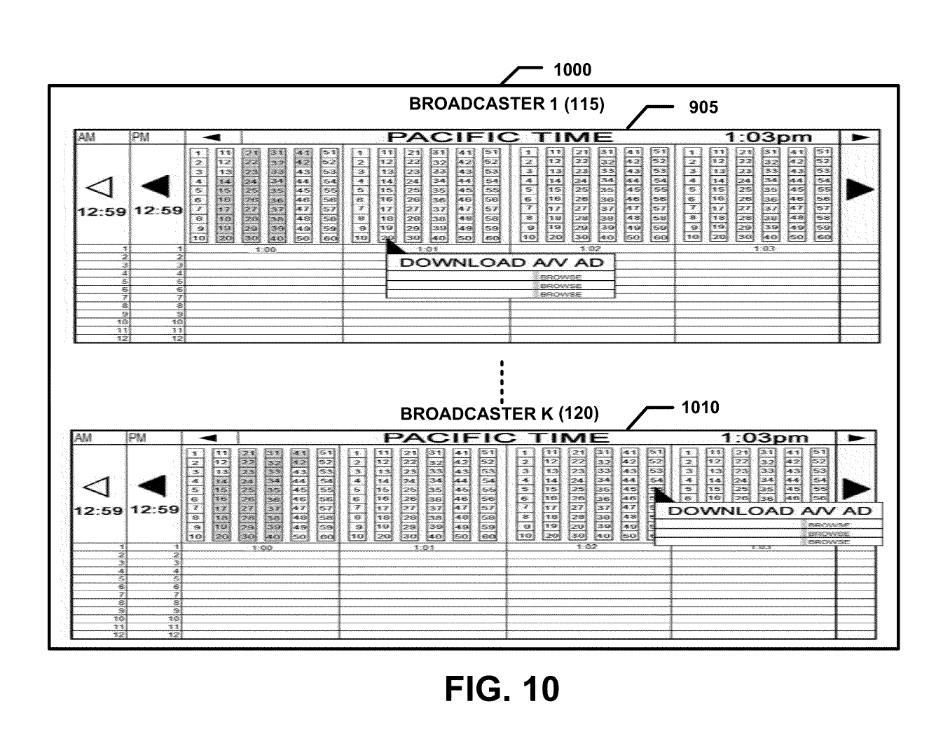

FIG. 10 represents a screen shot 1000 that is compiled by the interactive radio network 100, illustrating a compilation of the program schedules 900 for the advertisements, programmings, and messages that have been placed by the various users, broadcasting stations, and advertisers. As an example, program schedule 905 is associated with broadcaster 115, and program schedule 1010 is associated with broadcaster 120.

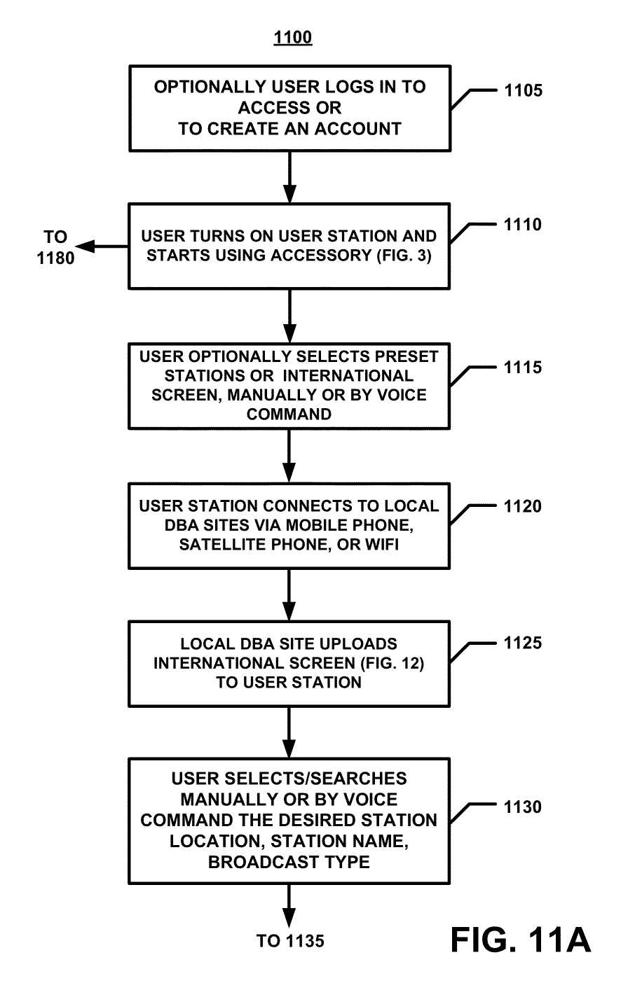

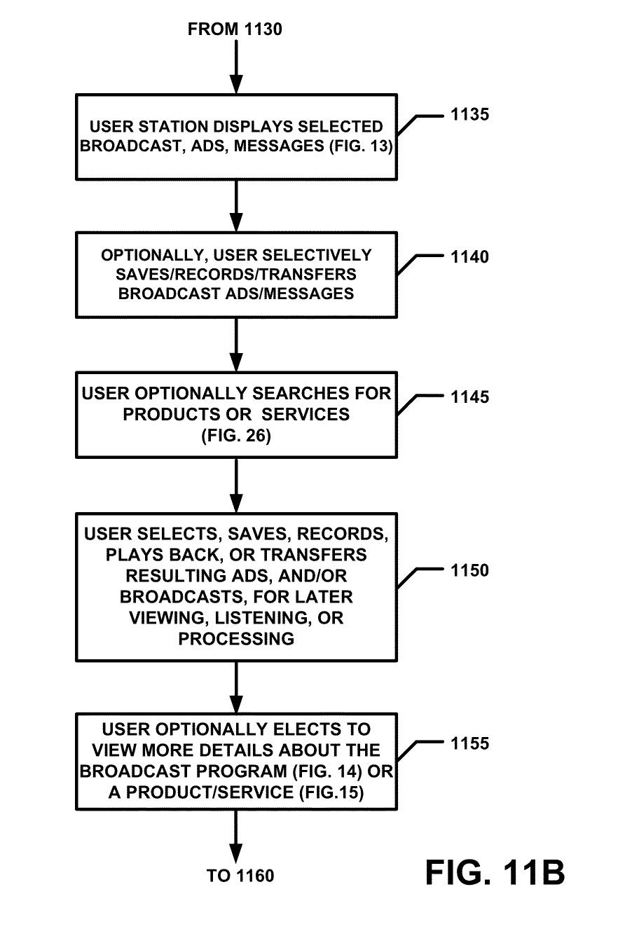

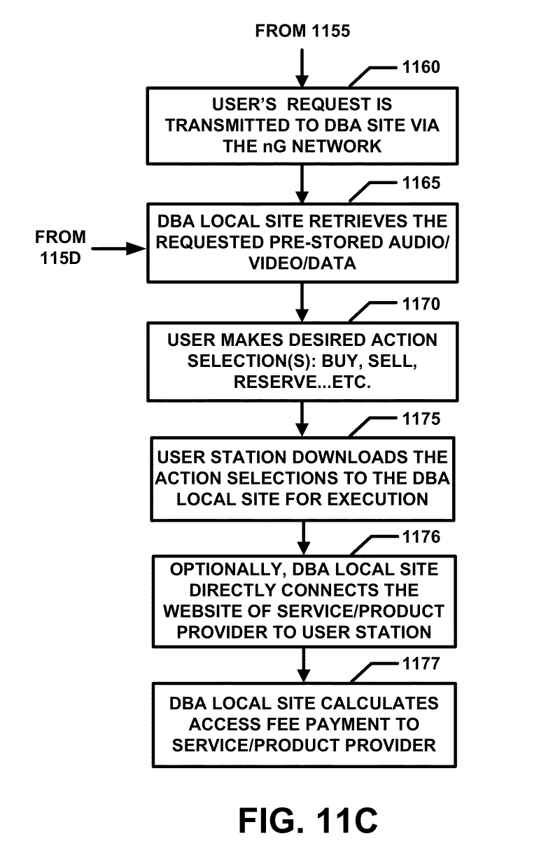

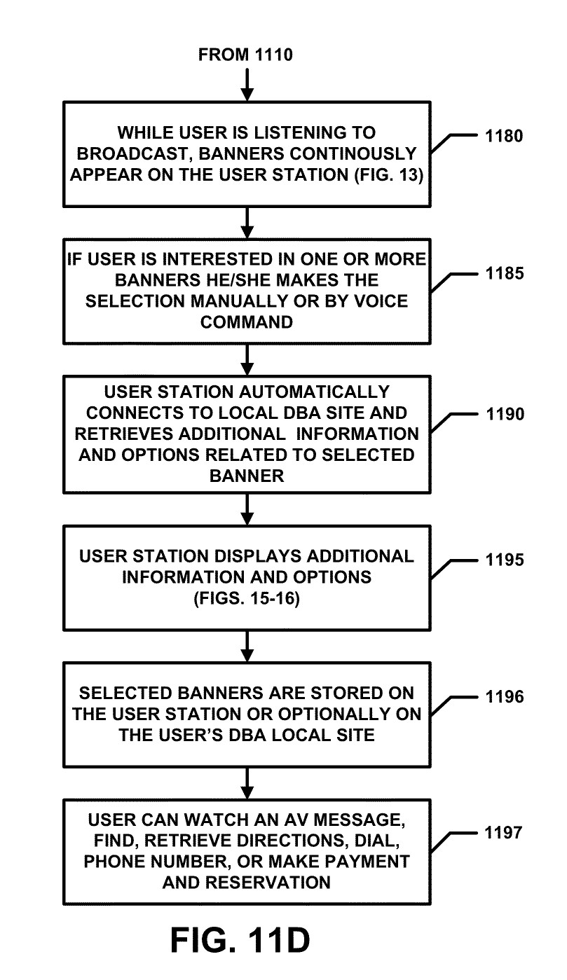

Referring now to FIG. 11, it is comprised of FIGS. 11A, 11B, 11C, and 11D that represent a flowchart illustrating a method of operation 1100 of local DBA site 210 of FIG. 2, for allowing the users, their corresponding user stations 105, 110 or computers, to access and use the interactive radio network 100.

In operation, in order for a user to access and use the interactive radio network 100, the user either uses his/her computer to access the local DBA site 210, or to create a new account, at step 1105. Alternatively, the user turns on the user station 105 at step 1110, and starts using at least one of the accessories illustrated in FIG. 3.

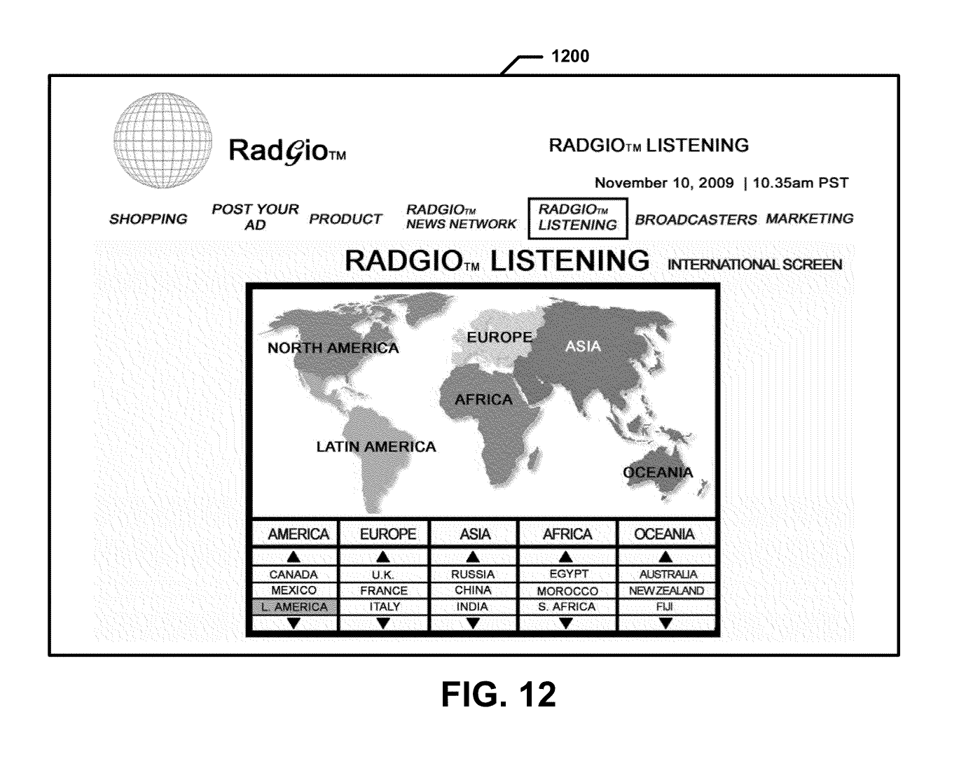

At step 1115, the user has the option to select a broadcasting station (e.g., 115) that is preset on the user station (or computer) 105, or an international screen 1200 (FIG. 12). The selection may be carried out manually, automatically, or by voice command.

In response to the selection at step 1115, the user station 105 connects, at step 1120, to one or more local DBA site 210 over a secondary communication network, such as over a mobile phone network as described herein, which is separate from the digital radio airwaves, such as for example via a mobile phone 320 on an nG network 355, a satellite phone, WIFI 380, or any other known or available network, such as Microsoft's Sync system that is currently bused by Ford Motor Company, to transmit the user selection. If access to international broadcast has been selected at step 1115, the local DBA site 210 uploads the international screen 1200 of FIG. 12 to the user station 105, at step 1125.

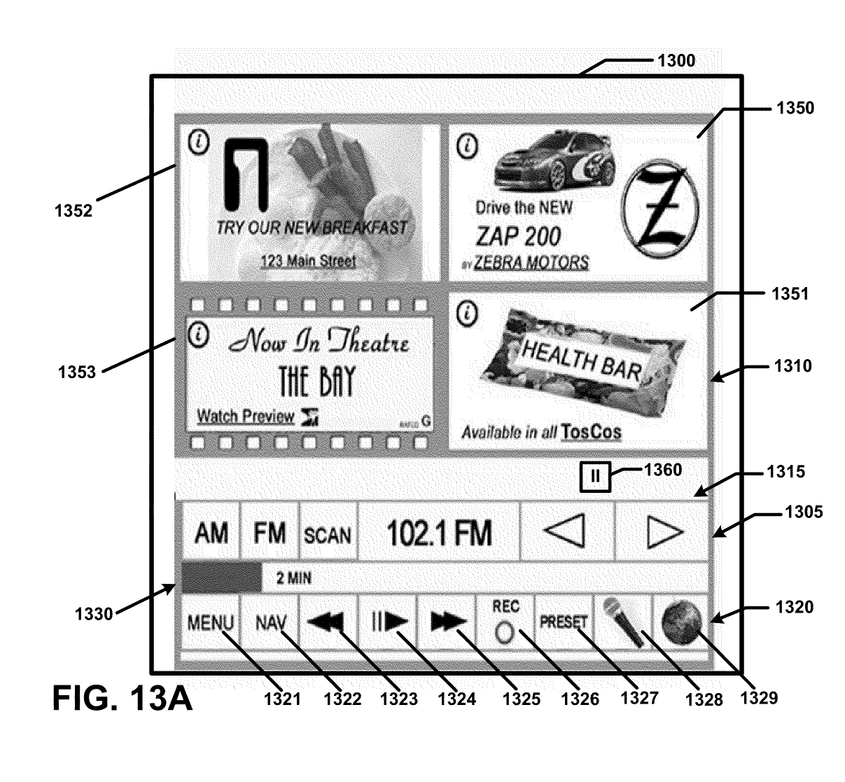

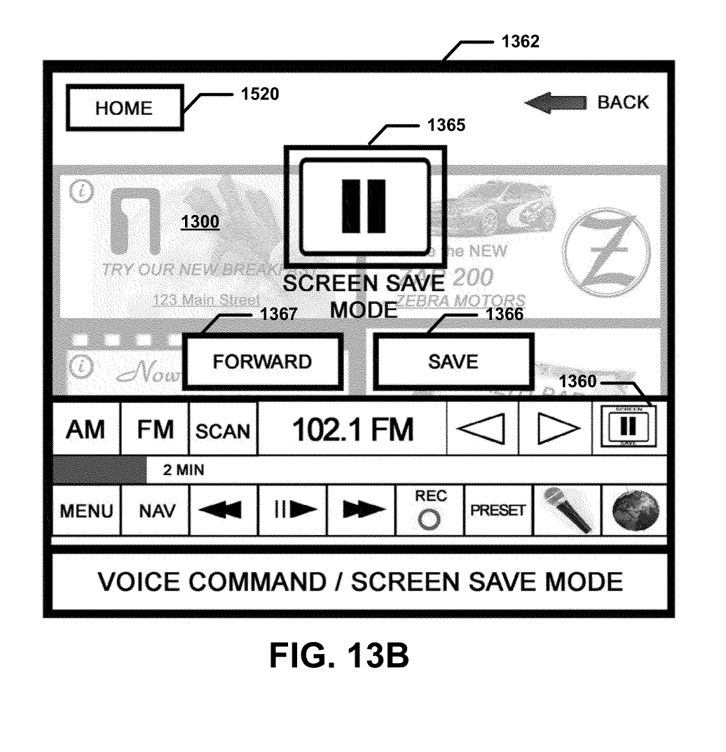

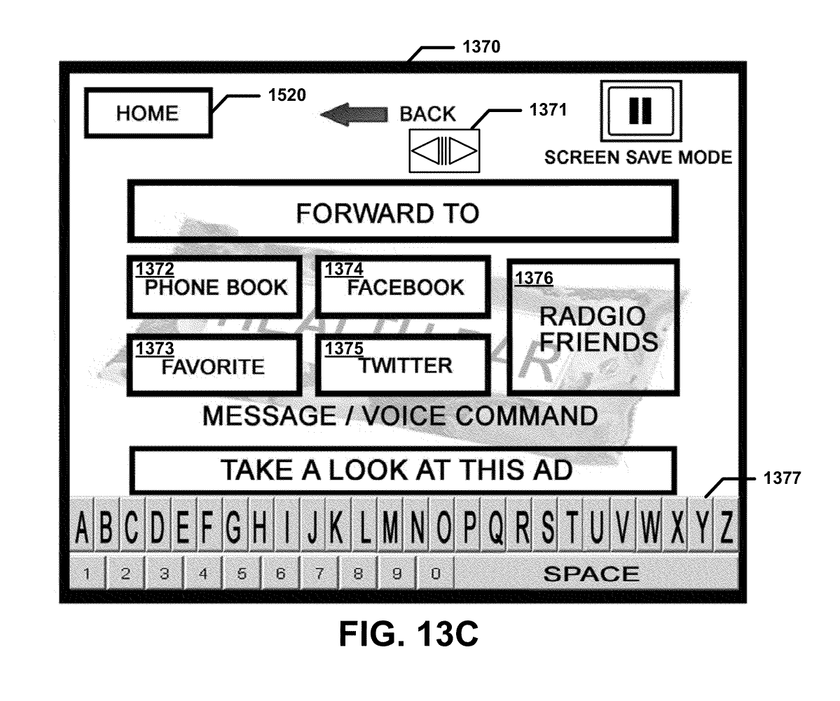

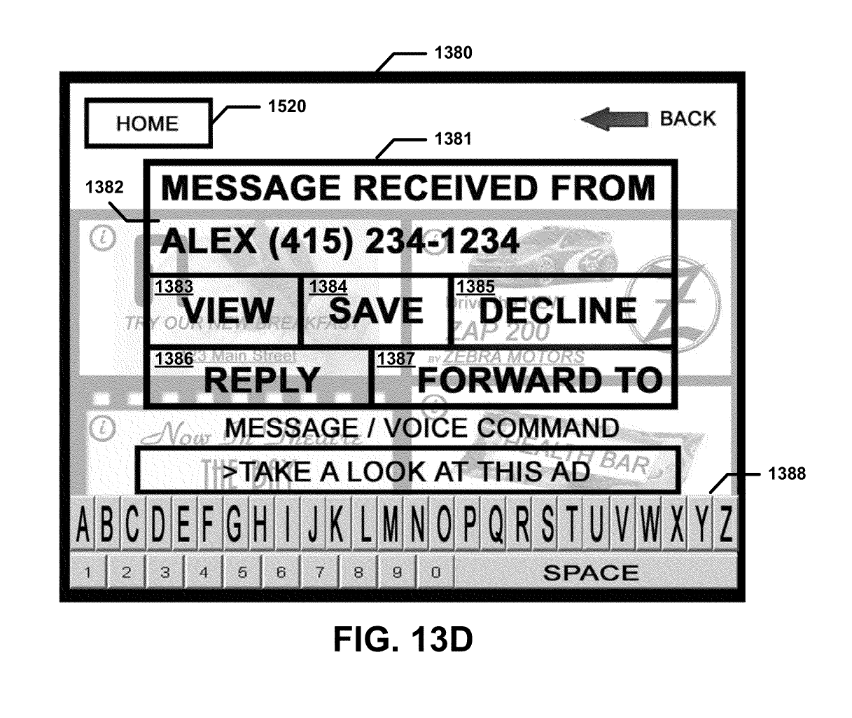

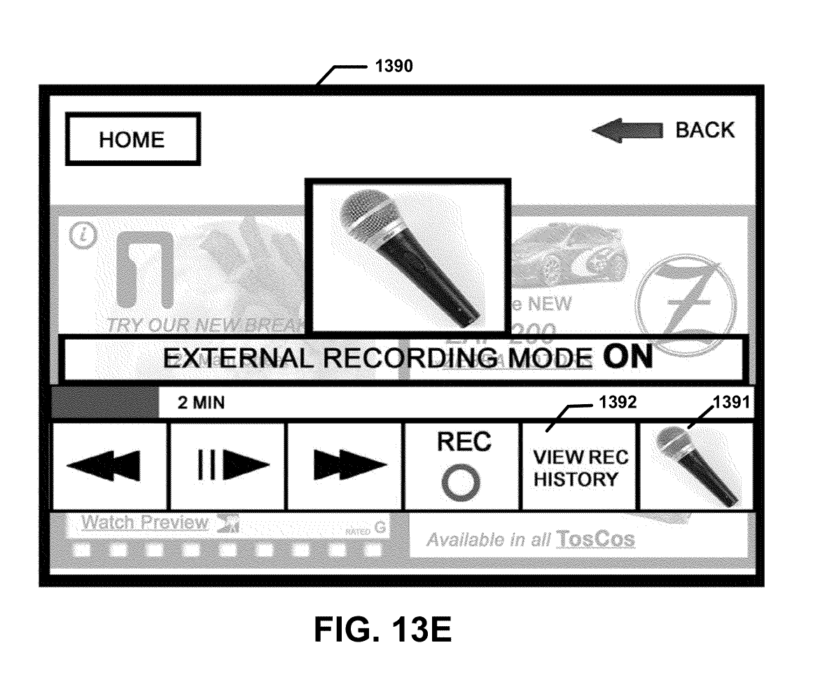

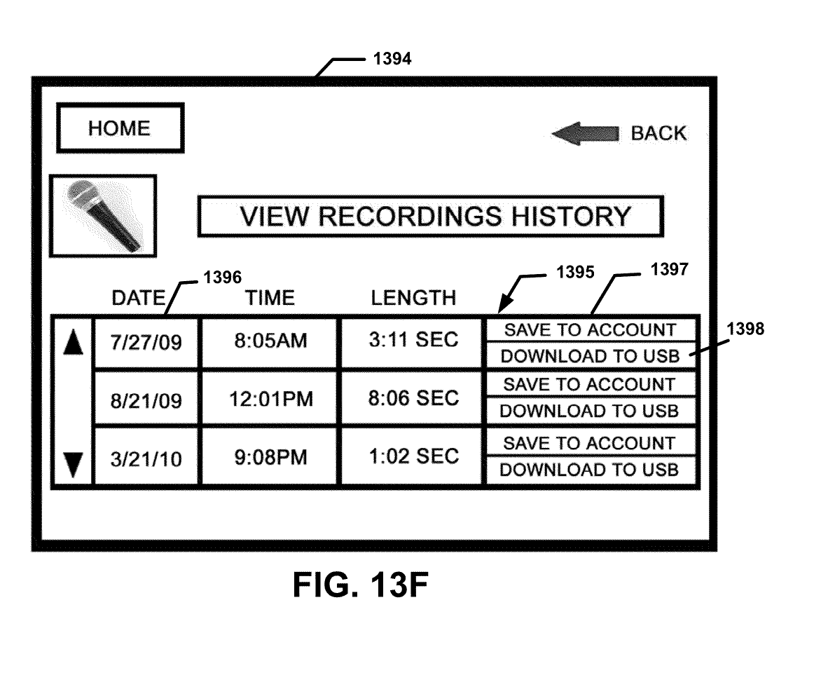

Once the international screen 1200 is displayed on the user station 105, the user has the option, at step 1130, to select or to search, manually or by means of a voice command, the desired station location, station name, broadcast type, or any other desired parameter. In response to the user's search criteria, the user station 105 displays, at step 1135, a screen frame 1300 that includes various control functions. FIG. 13A illustrates some of these control functions, such as broadcast information 1305 and a banners frame 1310 that include advertisements, messages, and other additional data that are selected by the user.

Optionally, at step 1140 of FIG. 11, the user saves or records the broadcast advertisements or messages, as it will be explained later in connection with FIGS. 13B, 13C, and 13D. The user may also exchange personalized messages with other user stations 105, 110.

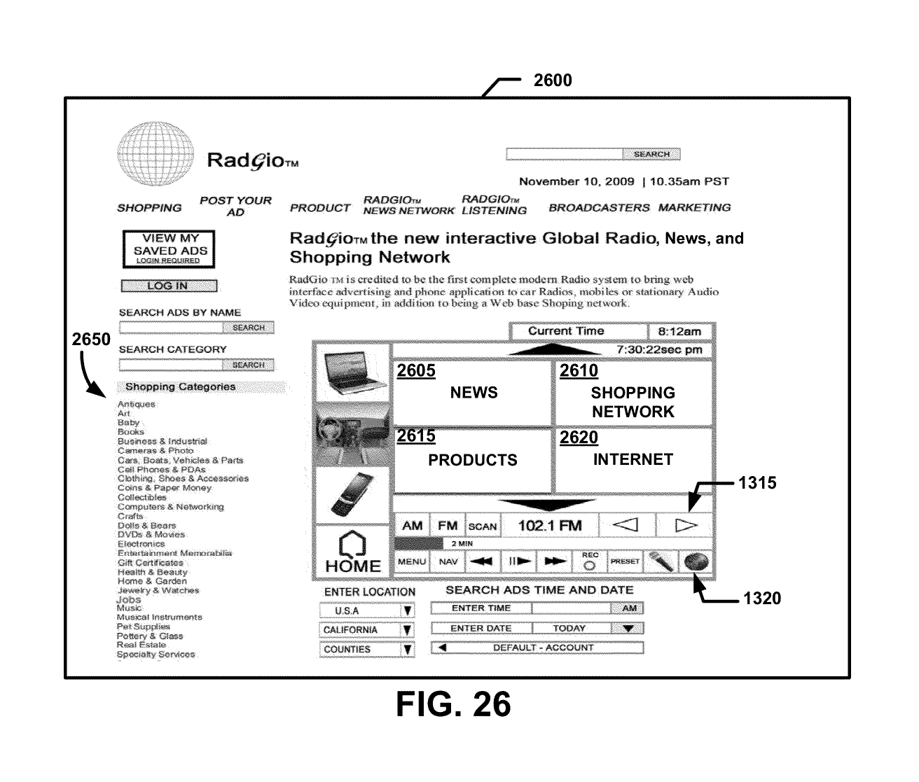

At step 1145, and as further illustrated in FIG. 26, the user optionally searches for desired products or services, as it will be described hereafter in more detail. At step 1150, the user has the option to select, save, record, play back, or transfer the resulting advertisements and/or broadcast programs for later viewing, listening, or processing.

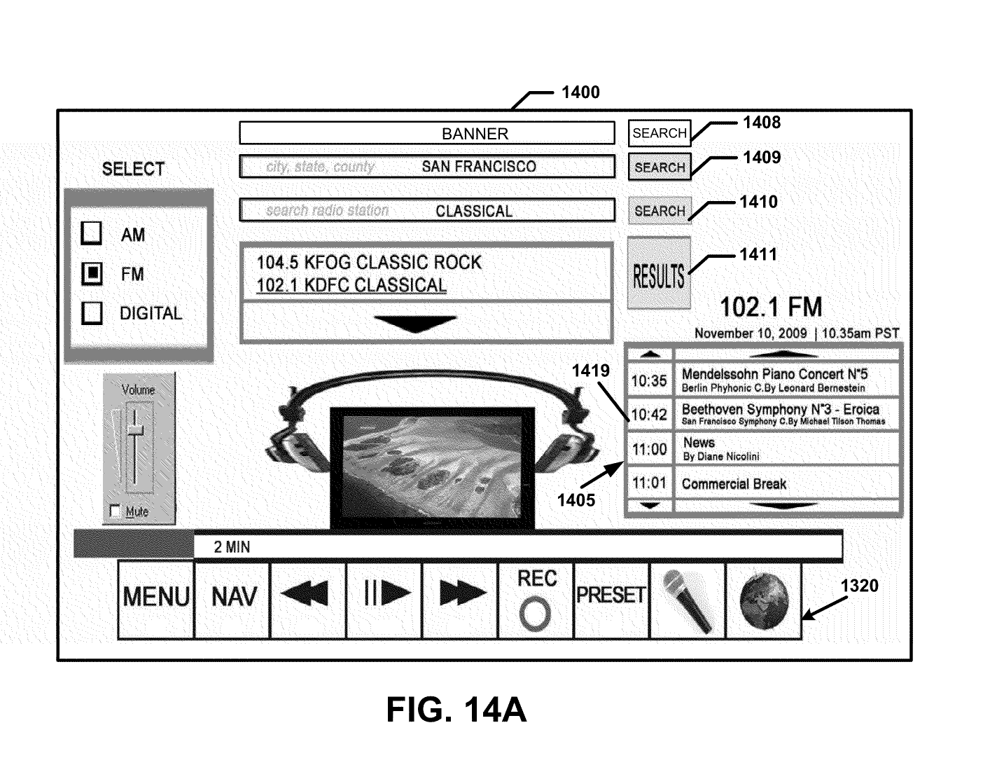

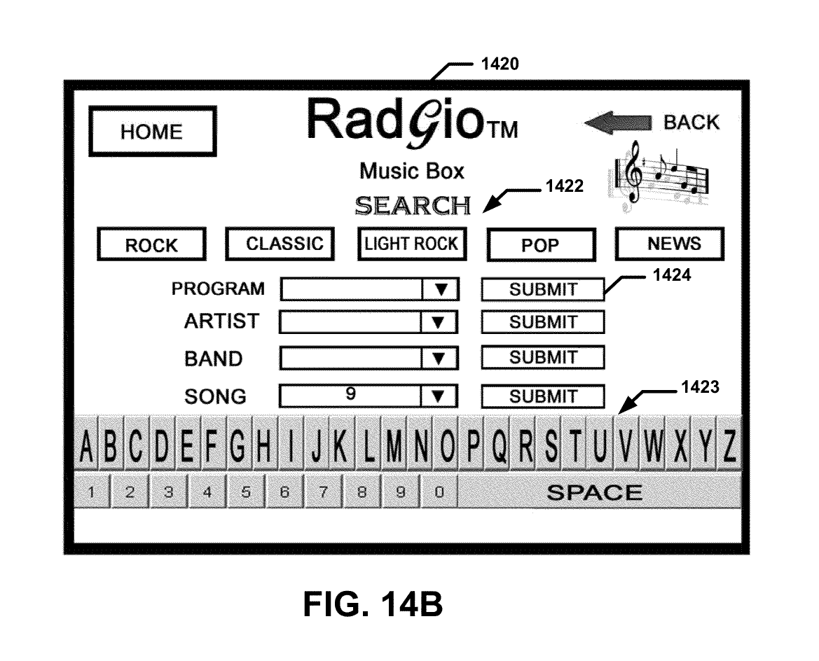

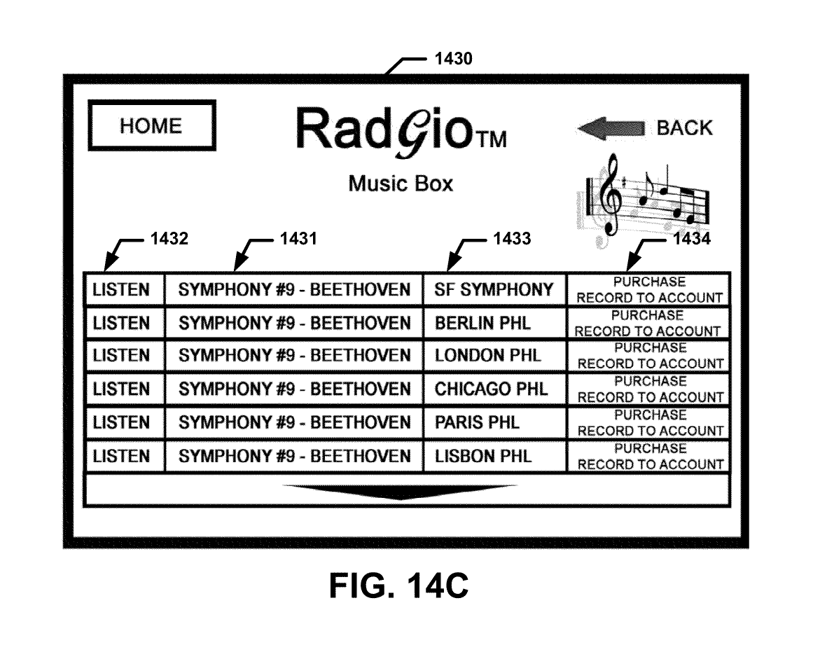

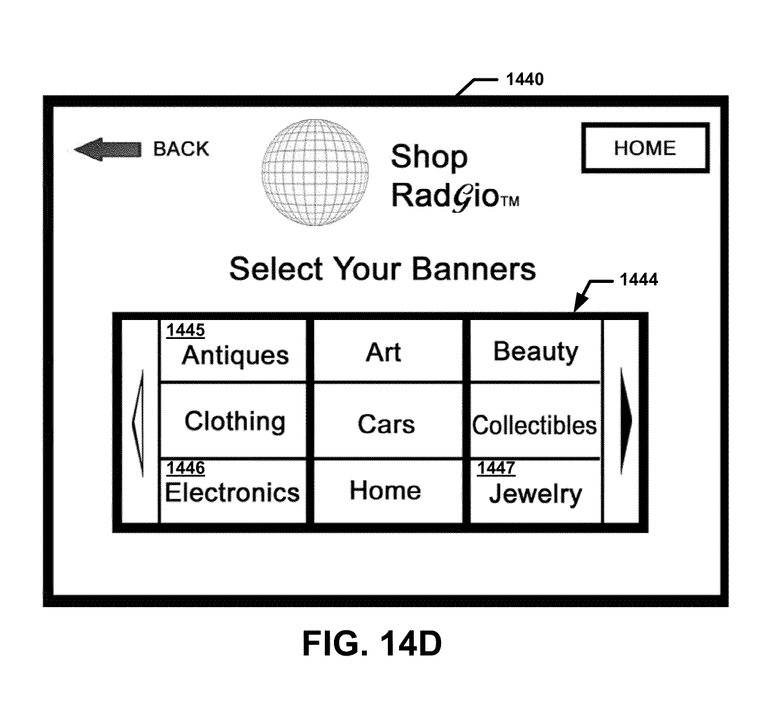

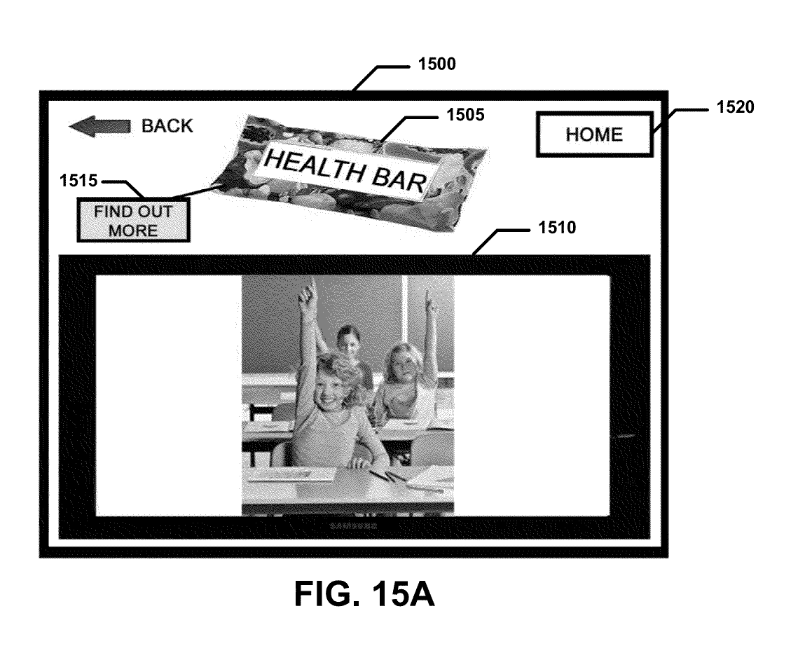

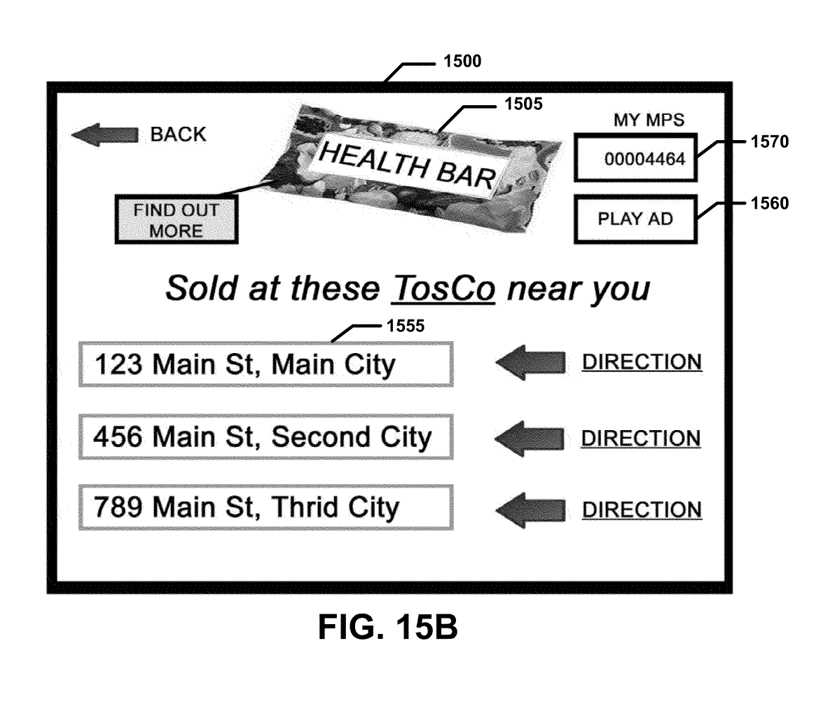

At step 1155, and with further reference to FIGS. 14, 15, the user may elect to view more details about the broadcast program, the product, or the service being advertised, as it will be described hereafter in more detail. The user's request is transmitted to the local DBA site 210 via, for example, the nG network 355, at step 1160.

At step 1165, the local DBA site 210 retrieves the requested pre-stored audio, video, and/or data. At step 1170, the user selects the desired processing step to be executed by the user station 105, such as play, fast forward, rewind, transfer to another user station 110, access the advertised web site, make a reservation, bid in an auction on a real time basis, etc., as it will be described herein in more detail.

At step 1175, the user station 105 connects to, and downloads the selected actions to the local DBA site 210 for execution. In response, the local DBA site 210 optionally directly connects the websites of the advertisers, service providers, manufacturers, etc. that are registered with the network 100, to the user station 105. As the user accesses these websites, the local DBA site 210 calculates the access fee payment or royalty to the registered websites owners, at step 1177.

At step 1180, as the user is listening to a broadcast program on the user station 105, banners are continuously displayed on the user station 105, as described herein in connection with FIGS. 5, 9, 10, and 13. At step 1185, if the user becomes interested in one or more banners or programs, he/she selects the desired banner or program either manually or by means of voice command.

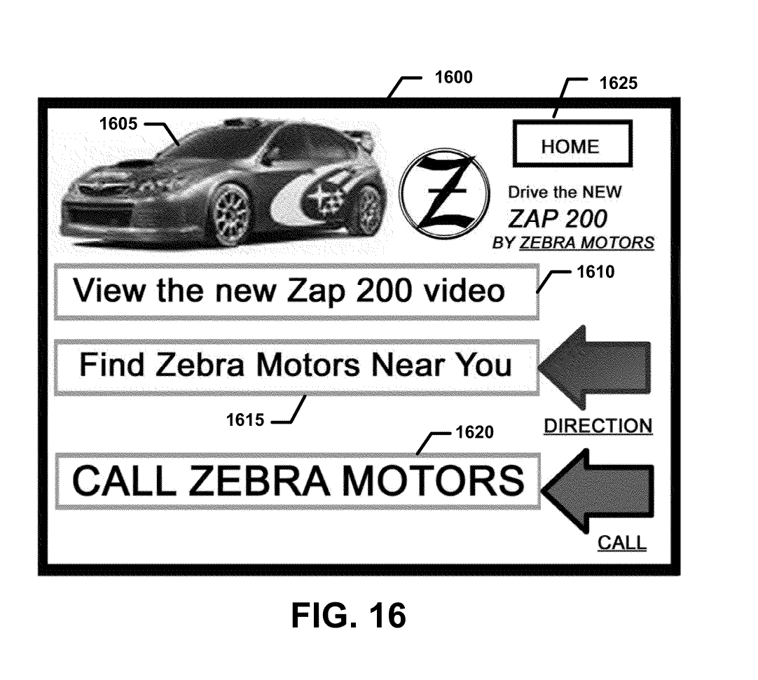

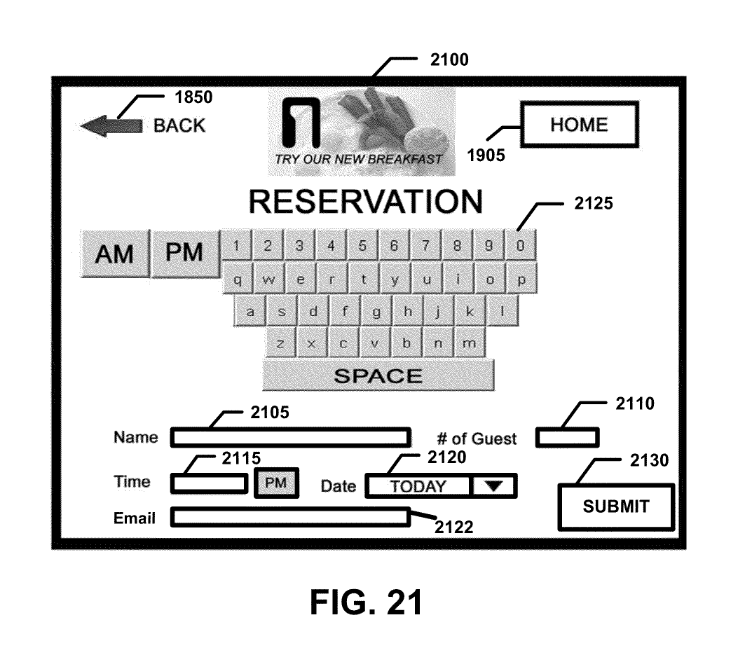

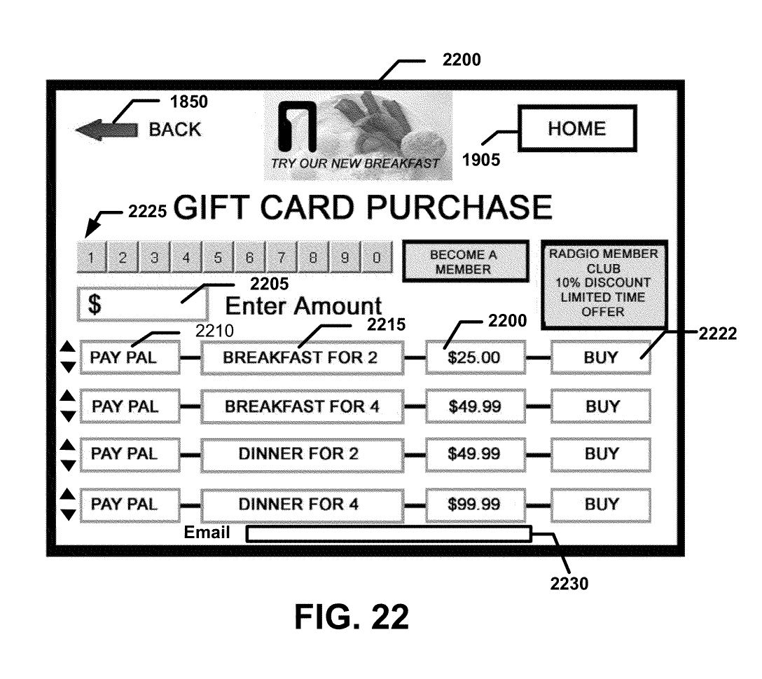

At step 1190, the user station 105 automatically connects to the local DBA site 210 site and retrieves additional information and/or options related to the selected banner or program. In turn, the local DBA site 210 retrieves the additional information and/or options, and transmits them to the user station 105 over the secondary communication network. At step 1195, the user station 105 displays such additional information, as illustrated in FIGS. 15-25.

At step 1196, the user station 105 stores the selected banner or program and its associated metadata. Optionally, this information is stored on the local DBA site 210 under the user-dedicated registered account. At step 1197, the user can retrieve and watch the stored information, and take the desired action, such as ask for directions, dial the phone number, make a payment or a reservation, or any other desired action that is permitted by the accessed website.

With reference to FIG. 13A, the broadcast information 1305 includes, for example, a row of broadcast station's associated data 1315 and a row of functions 1320 that are associated with the recording and playback functions of the interactive radio network 100. If the user wishes more information or control over the broadcast station's associated data 1315, the user could manually touch the broadcast station row 1315, or verbally order the user station 105 to provide additional information.

In response to the user's request, the user station displays a broadcast frame 1400 that illustrates additional broadcast information, and provides the user with additional controls and entries for search criteria, such as broadcast type, volume control, broadcast music type, a menu of upcoming broadcast, in addition to the functions row 1320.

For illustration purpose only and without any intent of limitation, the functions row 1320 includes a menu button 1321, a navigation button 1322, a rewind button 1323, a pause/play button 1324, a fast forward button 1325, a record button 1326, a preset button 1327, a microphone button 1328, and an international search button 1329. Considering each of these control buttons in greater detail, the menu button 1321 enables the user to display standard radio menu with, for example, CD/DVD/Navigation menu, in order to switch to a standard car radio standardized application menu. The navigation button 1322 enables the user to access the navigation functions in the vehicle.

The banners frame 1310 illustrates a plurality of banners, such as for example, a vehicle banner 1350, a nutrition banner 1351, a restaurant banner 1352, and a reservation banner 1353. It should be understood that in a preferred embodiment of the present invention, the preset button 1327 or the menu button 1321, enables the user to select, as favorite or bookmark, the desired banner types to be displayed. Alternatively, the banners frame 1310 will be displayed as broadcast by the broadcasting station 115 being displayed on the user station 105.

The record button 1326 enables the user to continuously record the audio, video, graphics, and text displayed on the current frame 1300. The recording progress is visually indicated by a progress bar 1330. Optionally, the user could change the recording setting by means of the menu button 1321, to instruct the user station to selectively record the desired information only, such as music or banners.

Alternatively, the user could select the broadcast station row 1315 to access the broadcast frame 1400 (FIG. 14A) and therefrom program the user station 105 to record a selected broadcast section that is either currently playing or that is scheduled to be broadcast at a later time. As an example, the user could program the user station 105 to record the News section 1405 that starts at 11:00 AM and ends at 11:01 AM.

The broadcast frame 1400 presents the user with several search fields, i.e., 1408, 1409, 1410, as well as a results field 1411. Considering for example the search field 1410, it allows the user to search for the desired music by, for example, music type, song, album name, singer, news about music, etc. (collectively referred to herein as “music”. More specifically, the selection of the exemplary search button 1410 causes the user station 105 to display a new search frame 1420 (FIG. 14B) that provides the user with advanced search fields 1422 and a keyboard 1423 for specific user entries.

The selection of a listed entry 1419 in either the broadcast frame 1400 or a desired submit button 1424 in the search frame 1420, will cause the user station 105 to display a new music box frame 1430 (FIG. 14C). In a preferred embodiment, the music box frame 1430 lists the music items 1431 that are available to the user. In this embodiment, the user is provided with an option to listen to the selected music item 1431 by pressing a corresponding button 1432.

In another embodiment, if for example the listed entry 1419 is selected by the user, the corresponding entry, Beethoven Symphony No. 3-Eroica, is displayed and listed in FIG. 14C as a music item 1431, providing the user with the options to either listen, purchase, or record the music item to the user's account. It is noteworthy to indicate that the selection of the music item 1419 (FIG. 14A), causes the selected music item 1419 to be processed, per the user demand, out of the broadcast time sequence. In the illustrated example, the selected item 1419 is scheduled to be broadcast at 10:42 AM, but is made available to the user at a user-selected time (prior or after the present time of 10:35 AM).

Referring back to the example illustrated in FIG. 14C, the user is provided with additional selection fields about the selected music item 1431. For instance the user is enabled to select a more specific parameter 1433 related to the music item, i.e., SF Symphony, Berlin Philharmonic (or Philharmonie), etc. The user is then enabled to make another desired selection using the corresponding field 1434, whereby the selected music item 1431 could be purchased or recorded to the user's account.

According to yet another embodiment, the user can make several selections of the music items 1419, 1431 and have the music items 1419, 1431 that have been selected from the various frames (or screen shots) described herein, assembled for processing (i.e., listening, recording, display, advertisements, messages, etc.) in a predetermined time sequence. As a result, each user has now acquired the ability to design his/her personalized broadcast, disregarding music items that do not appeal (or that are of no interest) to him/her.

With reference to the banner search button 1408 in FIG. 14A, the selection of this button 1408 in any of the available frames, will cause the user station 105 to display a new banner search frame 1440 (FIG. 14D). The banner search frame 1440 enables the user to filter the display of the banners on the user station 105, by a desired type 1444, or in a preferential order. For example, in one embodiment, the selection of the antiques button 1445 will limit the banners displayed on the user station 105 to antique-related items. Alternatively, the user may select a plurality of types, i.e., antiques button 1445, electronics button 1446, and jewelry button 1447, and assign to each button a corresponding processing parameter that will instruct the user station 105 to associate the display of these banner types with a desired order either in time, music item 1431, news items, etc. As a result, the user has now achieved control over the broadcast of the music items as explained earlier, and also over the broadcast of the banners.

The DBA system 200 enables the profiling of the users' stations for custom advertisements by the vendors. As an example, if a specific user consistently selects classic advertisements, the DBA system 200 builds and associates a corresponding “classic” profile for this particular user or user station. As a result, the DBA system 200 allows flexible advertisement search options by, for example, the users' stations based on keywords, product names, brands, geographical locations, and other search criteria, to create a specific advertisement that targets the user or user station.

If the user wishes to view or record (that is store or tape) a particular banner (e.g., 1351) of the banners frame 1310, he/she selects a screen save/forward button 1360, or possibly touches that banner 1351 if the screen is a touch screen, either manually or by voice command. The selection of the save/forward button 1360 causes the user station 105 to display a new screen frame 1362 (FIG. 13B), while the selection of the banner 1351 causes the user station 105 to display a new screen frame 1500 (FIG. 15A) in which the selected banner 1351 is enlarged and additional information and options are shown. As an example, the screen frame 1500 shows a health bar 1505, a video sub-frame 1510, additional data button 1515, and a home button 1520.

If the user selects the sub-frame 1510, the user station 105 connects to the local DBA site 210 via, for example, the mobile phone 320, the nG network 355, the satellite phone, the WIFI 380, or any other known or available network, in order to play the video commercial. Alternatively, the video commercial could be broadcast directly to the user station 105 as a hidden file, concurrently with the banner 1351. Using the functions row 1320, the user can store the video commercial for later viewing. The user could also use the fast forward button 1325 or the rewind button 1323 to fast forward or rewind through the video commercial.

If the user selects the additional data button 1515 of screen frame 1500, the user station 105 connects to the local DBA site 210 in order to upload the information about the product, the reseller, or the manufacturer. Such information could alternatively be broadcast directly to the user station 105 as a hidden file, concurrently with the banner 1351. Using the functions row 1320, the user can store the uploaded information for later viewing.

If the user selects the home button 1520 of screen frame 1500, the user station 105 connects to the local DBA site 210 in order to access the advertiser's, reseller's, or manufacturer's web site. The link to this web site could alternatively be broadcast directly to the user station 105 as a hidden file, concurrently with the banner 1351. Alternatively, the home button 1520 redisplays screen frame 1300 of FIG. 13A. The find out more button 1515 reveals more information about the product 1505, which information could have been possibly transmitted as a hidden file that is embedded with the advertisement broadcast. In another alternative embodiment, the find out more button 1515 redirects the user to the home page or site of the product's manufacturer, seller, or reseller.

The DBA system 200 operates continuously, 24 hours, 7 days a week. It can be integrated with numerous advertisements broadcast channels that can optionally be transmitted on various communications media and that are capable of using this invention, such as digital television, satellites, or other similar networks.

In an alternative embodiment, the selection of the banner 1351 (FIG. 13A) causes the user station 105 to display a screen frame 1550 (FIG. 15B) in which the selected banner 1351 is enlarged and additional information and options are shown. As an example, the screen frame 1550 shows the health bar 1505 as well as the locations/addresses 1555 where the health bar 1505 is available or sold. A play ad button 1560 enables the user to replay the commercial.

The screen frame 1550 also includes a “My MPS” display or counter 1570, where MPS. The MPS counter 1570 keeps a running and updated record based on the number of minutes (time) the user station 105 remains tuned to advertisement, in any screen frame described herein, i.e., 1300, 1500, 1550, etc. The MPS scores could be used by the product manufacturers, the broadcasting stations 115, the advertisers 125, the marketers 135 for business related purposes, such as to assess the success of the advertisement campaign. In addition, the users may use these MPS scores, for example, as redeemable points (with monetary values) toward the purchase of the advertised product 1505. The DBA system 200 allows credit-based points (My MPS—minute points) accumulation for reward redemption.

The selection of the screen the save/forward button 1360 in FIG. 13A, causes the user station 105 to display screen frame 1362 (FIG. 13B) in which the screen frame 1300 of FIG. 13A appears as a faded background, and a new foreground appears. In a preferred embodiment, a screen save mode icon 1365 appears clearly in order to advise the user of the operation mode of the user station 105. A new set of control buttons, such as a save button 1366 and a forward button 1367 also appear.

The selection of the save button 1366 causes a new screen save mode frame 1370 to appear on the user station 105, as illustrated in FIG. 13C. The screen save mode frame 1370 shows new function keys/buttons 1371 through 1376. Function key 1371 enables the user to scroll through the displayed advertisements that are displayed on screen frame 1300, and to select one or more advertisements. Once the advertisement is selected, it is displayed as a faded background. The user can then use the remaining function keys to effect the desired action.

As an example, the phone book key 1372 forwards the selected advertisement to the phone book. Similarly, the favorite key 1373, the Facebook key 1374, the twitter key 1375, and the Radgio friends key 1376 forward the selected advertisement to the desired destination or destinations. In addition to forwarding the advertisement, the user may personalize the transmittal of the advertisement by adding comments or notes using a keyboard 1377 or the microphone button 1328.

FIG. 13D illustrates a recipient screen 1380 that is displayed on a computer or user station 105 of a recipient to whom the advertisement has been forwarded, as explained earlier in connection with FIGS. 13A, 13B, 13C. An information box 1381 appears, showing the sender's identification or information (1382), and provides the recipient with the options to view (1383), save (1384), or decline (1385) the forwarded message. A reply key 1386 and a forward key 1387 are also provided to enable the recipient to either reply or forward the message, as desired, optionally using a keyboard 1388.

Referring back to FIG. 13A, if the user wishes to view or record the vehicle banner 1350 of the banners frame 1310, he/she selects that banner 1350, either manually or by voice command. This selection causes the user station 105 to display a new screen frame 1600 in which the selected banner 1350 is enlarged and additional information and options are shown. As an example, the screen frame 1600 shows a vehicle 1605, a video button 1610, a locator button 1615, a call button 1629, and a home button 1625.

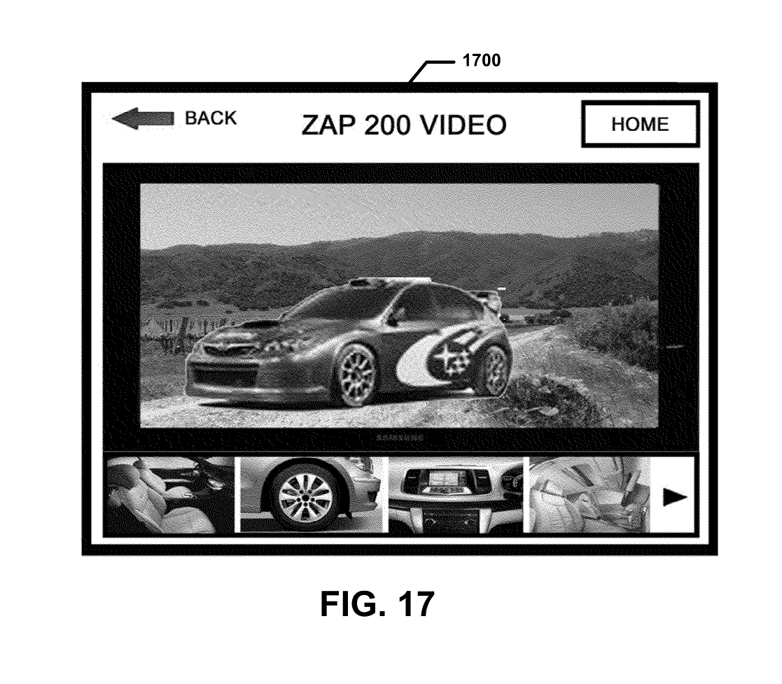

If the user selects the video button 1610, the user station 105 connects to the local DBA site 210, in order to play a video commercial 1700 (FIG. 17). Alternatively, the video commercial 1700 could be broadcast directly to the user station 105 as a hidden file, concurrently with the banner 1350. Using the functions row 1320, the user can store the video commercial for later viewing. The user could also use the fast forward button 1325 or the rewind button 1323 to fast forward or rewind through the video commercial.

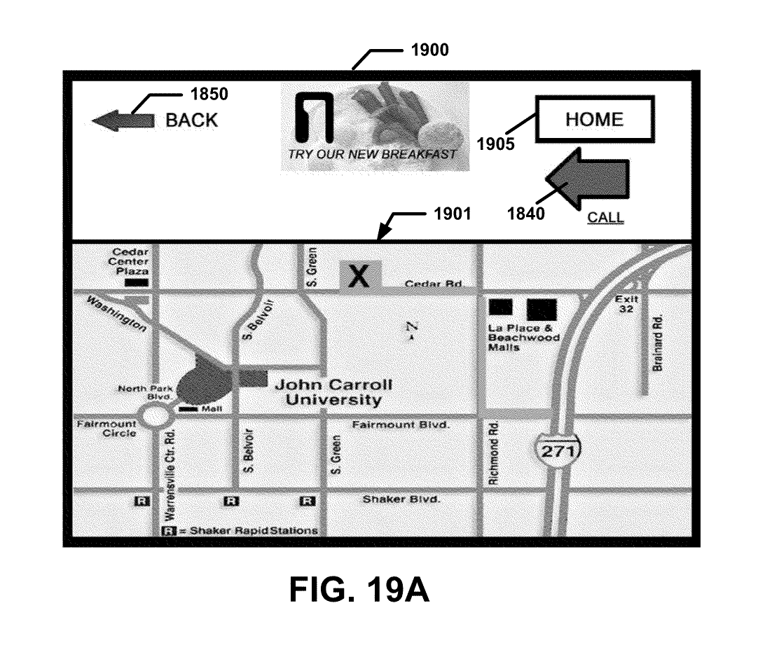

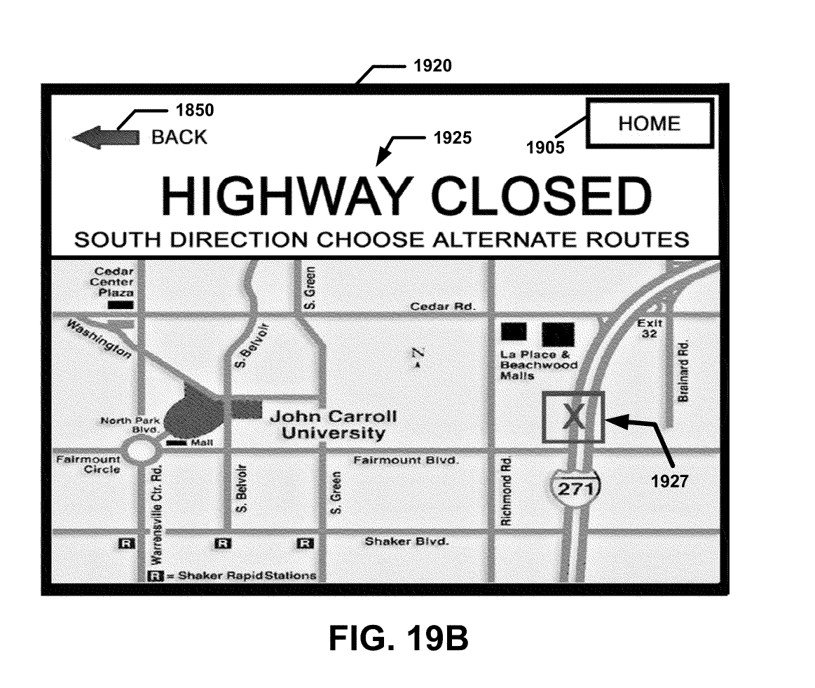

If the user selects the locator button 1615 of screen frame 1600, the location of the user station 105 is determined by the GPS receiver 315 and transmitted to the local DBA site 210. The user station 105 connects to the local DBA site 210 in order to upload data about the various store locations within a predetermined distance from the user station 105. In turn, the user selects the desired location and transmits this selection to the local DBA site 210. The local DBA site 210 sends a map (similar to map 1901 of FIG. 19) containing directions to the selected location.

If the user selects the call button 1620, the user station 105 establishes an audio connection with the mobile phone 320 and dials the telephone associated with the banner 1350. Such telephone number could alternatively be broadcast directly to the user station 105 as a hidden file, concurrently with the banner 1350. Using the functions row 1320, the user can store the uploaded information for later viewing.

If the user selects the home button 1625 of screen frame 1600, the user station 105 connects to the local DBA site 210 in order to access the advertiser's, reseller's, or manufacturer's web site. The link to this web site could alternatively be broadcast directly to the user station 105 as a hidden file, concurrently with the banner 1350.

Referring back to FIG. 13A, if the user wishes to view or record the restaurant banner 1352 of the banners frame 1310, he/she selects that banner 1352, either manually or by voice command. This selection causes the user station 105 to display a new screen frame 1800 in which the selected banner 1352 is enlarged and additional information and options are shown.

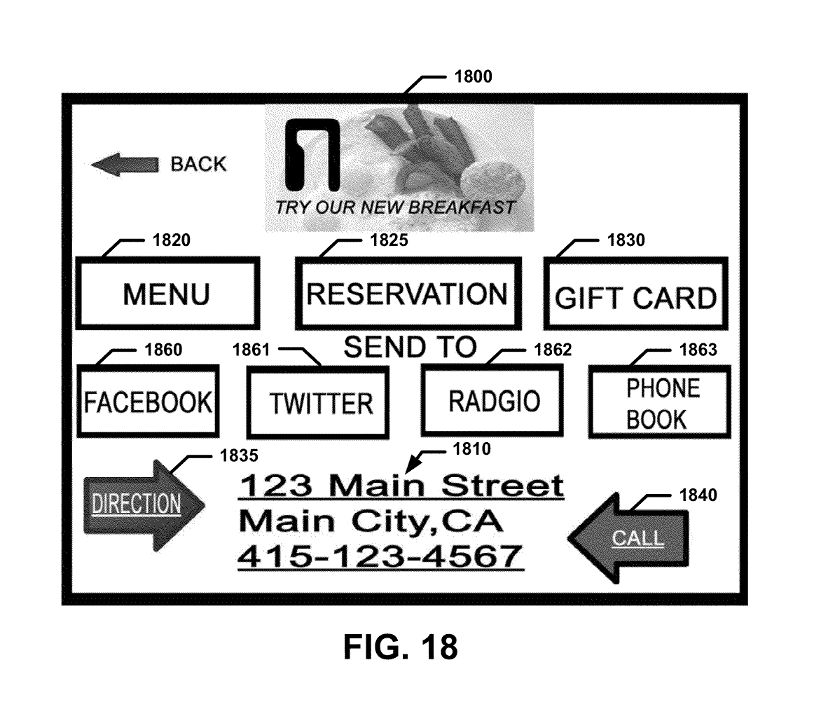

As an example, the screen frame 1800 (FIG. 18) shows a picture of a breakfast plate 1805, along with the address 1810 and contact information (e.g., telephone number 1815) for the business entity providing the advertised meal. The screen frame 1800 also shows a menu button 1820, a reservation button 1825, a gift card button 1830, a back button 1850. The screen frame 1800 could further include additional information and control options, such as a locator or direction button 1835, a call button 1840, a video button (as previously described but is not shown), a home button (not shown), and any other suitable control button, such as a plurality of destination buttons 1860, 1861, 1862, 1863.

In this example, the selection of any destination button 1860, 1861, 1862, and/or 1863, instructs the user station 105 to forward the selected item, i.e., advertisement, message, music item (FIGS. 14A-14D), to a desired destination. The Facebook key 1860, the twitter key 1861, the phone book key 1863, and the Radgio key 1862 forward the selected item to the desired destination or destinations. In addition to forwarding the item, the user may personalize the transmittal by adding comments or notes using a keyboard or a microphone button, as indicated earlier. Additional destination keys (or buttons) may be included in the screen frame 1800, such as a phonebook key, a favorite key, etc.

If the user selects the locator button 1835 of screen frame 1800, the location of the user station 105 is determined by the GPS receiver 315 and transmitted to the local DBA site 210. The user station 105 connects to the local DBA site 210 in order to upload data about the various store locations within a predetermined distance from the user station 105. In turn, the user selects the desired location and transmits this selection to the local DBA site 210. The local DBA site 210 sends a map 1901 as part of a map frame 1900, as shown in FIG. 19A, containing directions to the selected location.

A call button 1840, a home button 1905, and a back button 1850 can be added to the map frame 1900. The home button 1905 allows the user to access the home web site (e.g., 1800), while the back button 1850 routes the user back to a previous screen frame.

In a preferred embodiment illustrated in FIG. 19B, a notification frame 1920 displays a map 1925 on the user station, detailing the location 1927 of the accident, delay, detour, or otherwise disruption, that may occur along the selected route or routes, leading to the user's selected destination.

The user station 105 may alternatively upload the address 1810 of the selected restaurant to the GPS 315. In turn, the GPS 315 provides the necessary driving or map directions to the physical location of the restaurant. The DBA system 200 can be interconnected to the GPS 315 to provide real time location based advertisements and vendors' coupons.

If the user selects the call button 1840, the user station 105 establishes an audio connection with the mobile phone 320 and dials the telephone associated with the banner 1352. Such telephone number could alternatively be broadcast directly to the user station 105 as a hidden file, concurrently with the banner 1352. Using the functions row 1320, the user can store the uploaded information for later viewing.

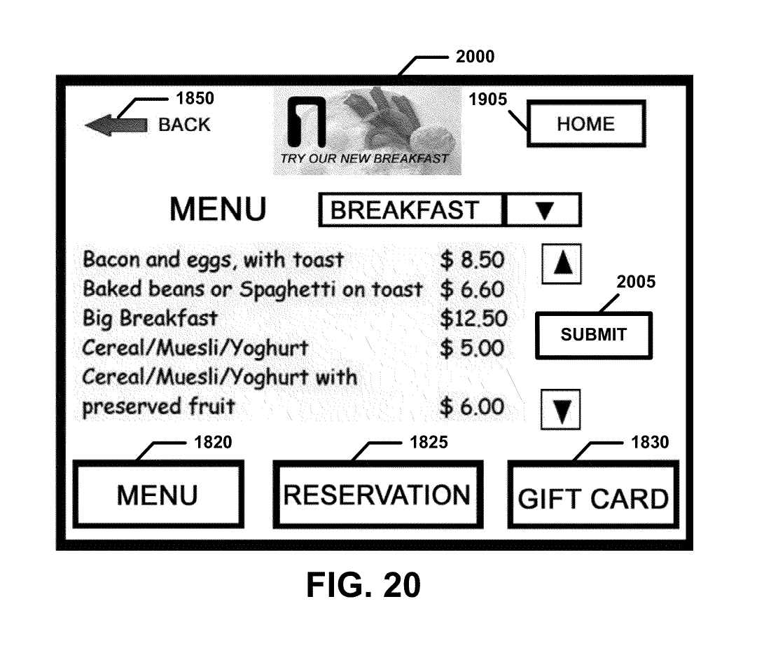

If the user selects the menu button 1620 of screen frame 1800, the user station 105 connects to the local DBA site 210 in order to access a menu 2000 (FIG. 20) offered by the restaurant. The link to the restaurant's web site could alternatively be broadcast directly to the user station 105 as a hidden file, concurrently with the banner 1352. At the menu screen frame 2000, the user can make the desired selection, such as select the meal type: breakfast, lunch, dinner, brunch, etc., and specify the desired order. A submit button 2005, enables the user to send his/her selection to the restaurant, via the user station 105 and its corresponding accessory, for delivery or pickup.

If the user selects the reservation button 1825 in FIG. 18 or 20, the user station 105 connects to the local DBA site 210 and retrieves a reservation screen frame 2100 for display on the user station 105. The reservation screen frame 2100 enables the user to enter his/her corresponding information in the appropriate fields 2105, 2110, 2115, 2120, 2122, using a keyboard 2125. The user then submits the entered information using a submit button 2130, and a communication, such as a confirmation, is then sent back from the restaurant's web site to the user station 105 or to the user's email that was entered in field 2122.

If the user selects the gift card button 1830 in FIG. 18 or 20, the user station 105 connects to the local DBA site 210 and retrieves a gift card screen frame 2200 for display on the user station 105. The gift card screen frame 2200 enables the user to enter his/her corresponding information in the appropriate fields 2205, 2210, 2215, 2220, using a keyboard 2225. The user then submits the entered information using a submit or buy button 2222, and a communication, such as a receipt, is then sent back from the restaurant's web site to the user station 105 or to the user's email that was entered in field 2230.

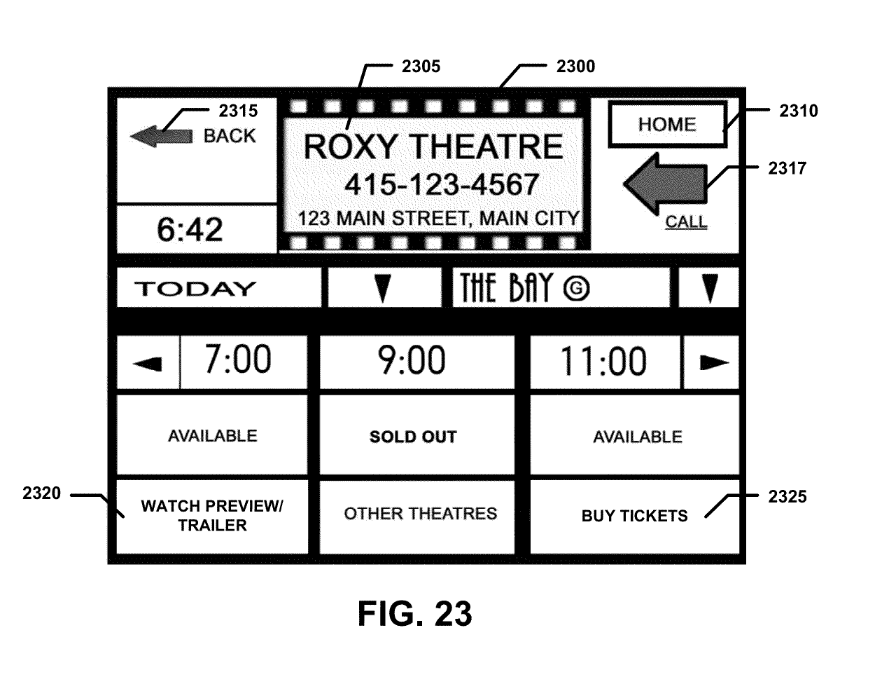

Referring back to FIG. 13A, if the user wishes to view or record the reservation banner 1353 of the banners frame 1310 (FIG. 13A), he/she selects that banner 1353, either manually or by voice command. This selection causes the user station 105 to display a new screen frame 2300 (FIG. 23) in which the selected banner 1353 is illustrated with additional information and options. As an example, the screen frame 2300 shows a subframe 2305 that includes the theater's telephone number and address, and another subframe 2350 that lists the available movies, movie theaters, schedules, and seat availability.

The screen frame 2300 also shows a home button 2310, a back button 2315, a call button 2317, a watch preview/trailer button 2320, a buy tickets button 2325, search for other theaters button 2330, and any other suitable control button.

If the user selects the address link in the subframe 2305, the location of the user station 105 is determined by the GPS receiver 315 and transmitted to the local DBA site 210. The user station 105 connects to the local DBA site 210 in order to upload data about the various store locations within a predetermined distance from the user station 105. In turn, the user selects the desired location and transmits this selection to the local DBA site 210. The local DBA site 210 sends a map (or directions), similar to the map 1901 shown in FIG. 19, containing directions to the selected theater.

The home button 2310 allows the user to access the home web site of the movie theater, while the back button 2315 routes the user back to a previous screen frame.

If the user selects the call button 2317, the user station 105 establishes an audio connection with the mobile phone 320 and dials the telephone associated with the banner 2300. Such telephone number could alternatively be broadcast directly to the user station 105 as a hidden file, concurrently with the banner 2300. Using the functions row 1320, the user can store the uploaded information for later viewing.

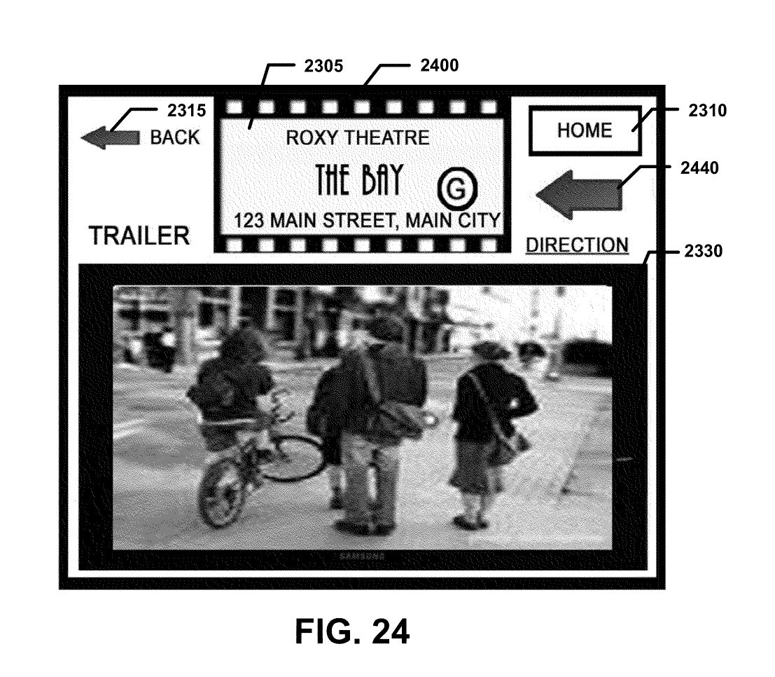

If the user selects the watch preview/trailer button 2320 of screen frame 2300, the user station 105 connects to the local DBA site 210 in order to access a preview screen frame 2400 (FIG. 24). At the preview screen frame 2400, the user can make the desired selection, such as select the back button 2315, the home button 2310, the direction button 2440, or the trailer subframe 2330.

If the user selects the direction (or locator) button 2440 of screen frame 2400, the location of the user station 105 is determined by the GPS receiver 315 and transmitted to the local DBA site 210. The user station 105 connects to the local DBA site 210 in order to upload data about the various theater locations within a predetermined distance from the user station 105. In turn, the user selects the desired location and transmits this selection to the local DBA site 210. The local DBA site 210 sends a map, similar to the map 1901 of FIG. 19, containing directions to the selected location.

By selecting the trailer subframe 2330, the user station 105 plays the selected trailer video, which could have been either pre-transmitted to the user station 105 upon selection of the preview screen frame 2400, or it could be uploaded to the user station 105 upon selection of the trailer subframe 2330 via the networks that are available to the user station 105.

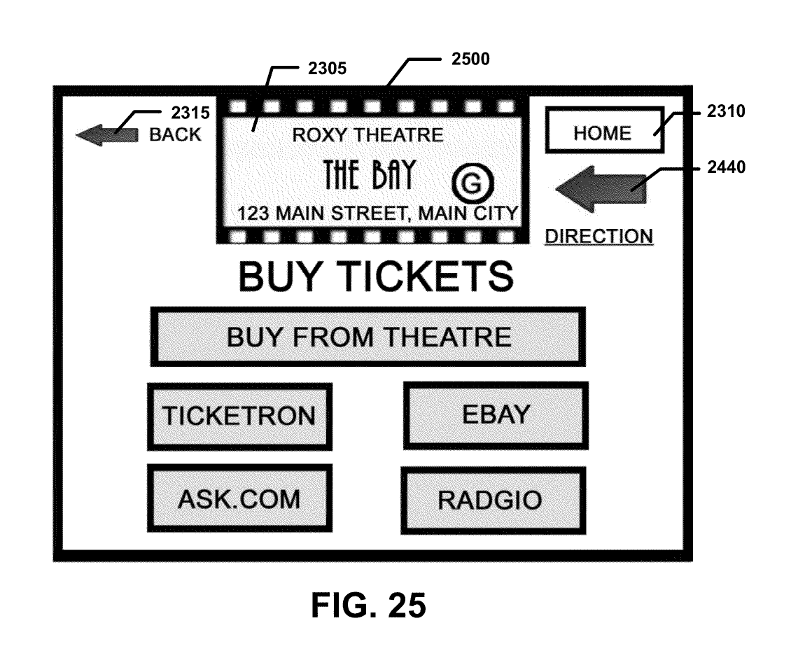

If the user selects the buy tickets button 2325 in FIG. 23, the user station 105 connects to the local DBA site 210 and retrieves a reservation screen frame 2500 (FIG. 25) for display on the user station 105. The reservation screen frame 2500 enables the user to buy the tickets to the desired theater and to make the appropriate payments.

FIG. 26 illustrates a frame 2600 that can displayed on the user station 105 as a screen frame, or on the user's computer as a screen shot. Considering for example, the use of the screen frame 2600 in operation with the user station 105, it includes all the functions described earlier in connection with the screen frame 1300 of FIG. 13A.

The screen frame 2600 could illustrate banners in addition to those displayed in screen frame 2300. As an example, the screen frame displays a news banner 2605, a shopping network banner 2610, a products banner 2615, and an internet banner 2620. The screen frame 2600 also illustrates a search field and additional links and optional links 2650.

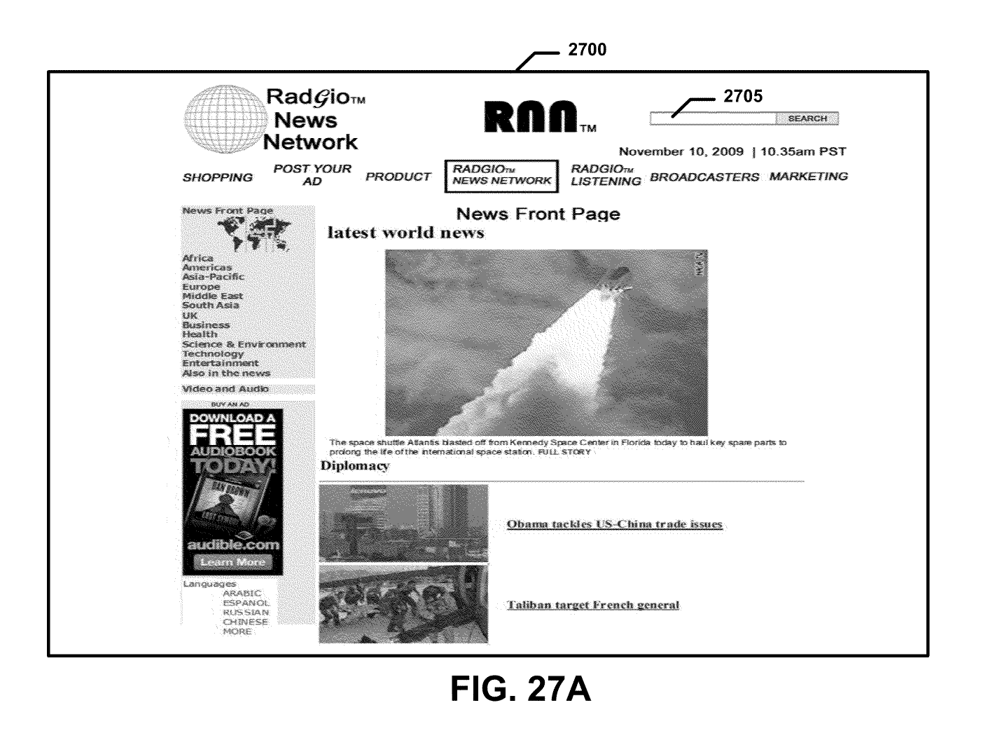

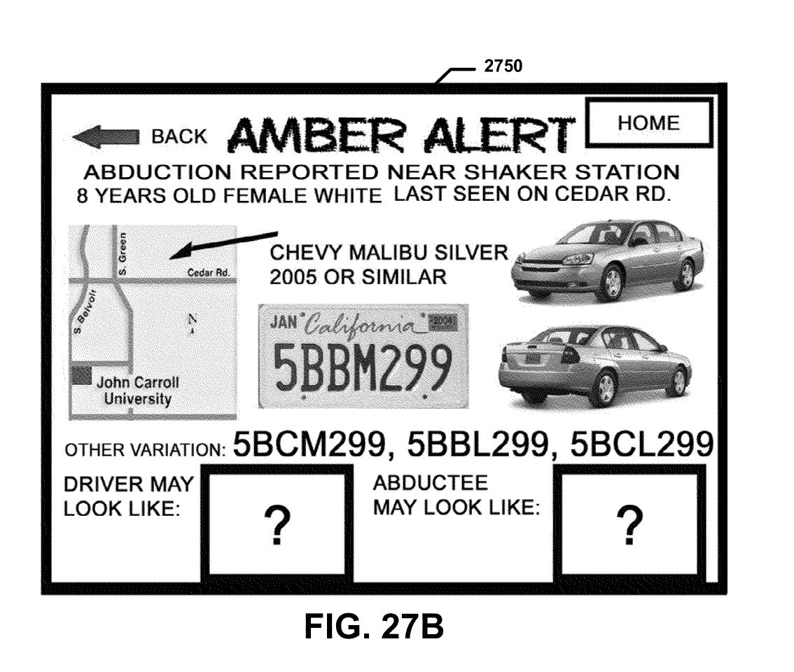

If the user selects the news banner 2605, the user station 105 automatically connects to the local DBA site 210 and displays a news screen frame 2700 (FIG. 27A), which illustrates the current news and which provides the user with the option to search for the desired news, using field 2705. The news screen frame 2700 allows the user to view audio and video clips of news, and to tape the news using the row of functions 1320, as described earlier.

The news banner 2605 (or another more specific banner, key, or button) may display an alert frame 2750 (FIG. 27B) that advises the user of the weather (by for example, weather channels), and of imminent dangers, catastrophes, or natural disasters i.e., floods, earthquakes, etc., in the user's geographical area, and advises the user on recommended actions. This service may be tied to governmental alarm or alert systems. It should be clear that the alert frame 2750 may automatically supersede (or be overlaid on) the other frames being broadcast, without an express selection by the user.

If the user selects the shopping network banner 2610 (FIG. 26), the user station 105 automatically connects to the local DBA site 210 and displays a shopping network screen frame 2700 (FIG. 27), which illustrates an online shopping network and which provides the user with the option to search for the desired product, using search field 2805. The shopping network screen frame 2800 allows the user to view audio and video clips of advertised products 2810, and to interact with the local DBA site 210 in order to purchase, sell, or otherwise trade the products 2810. The shopping network screen frame 2800 also allows the user to tape the advertisements using the row of functions 1320, as described earlier.

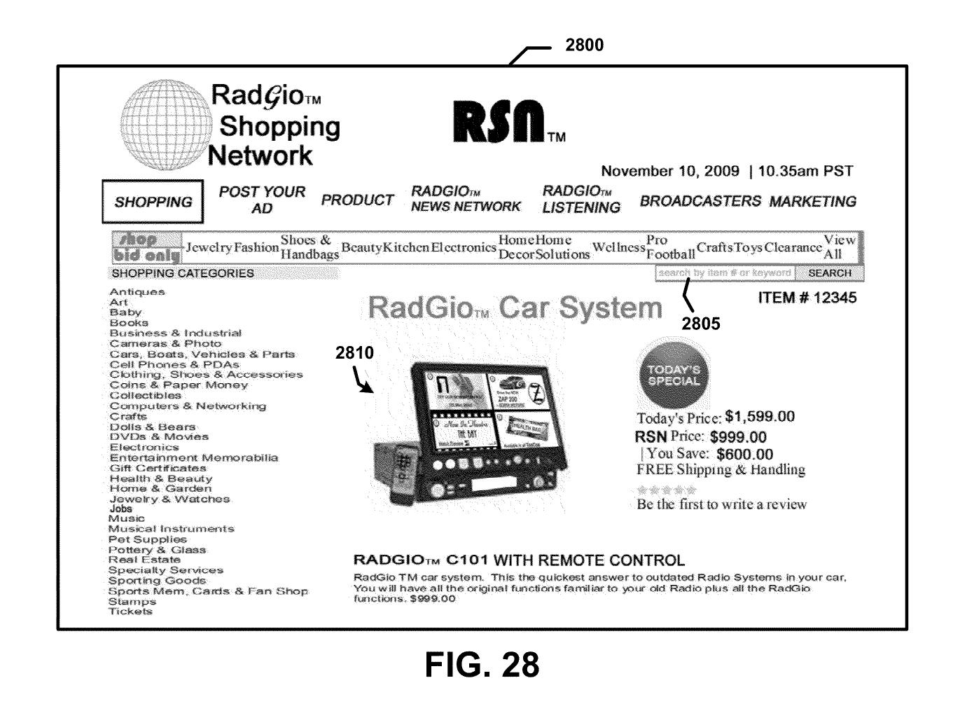

If the user selects the products banner 2615 (FIG. 26), the user station 105 automatically connects to the local DBA site 210 and displays a products screen frame 2900 (FIG. 29), which lists products available for purchase by the user, such as products 2915, 2920, 2925, 2930, 2935. The products screen frame 2900 also provides the user with the option to search for the desired product, using a search field 2905. The products screen frame 2900 allows the user to view audio and video clips of advertised products 2810 (FIG. 28), and to interact with the local DBA site 210 in order to purchase, sell, or otherwise trade the advertised products 2915, 2920, 2925, 2930, 2935. The products screen frame 2900 also allows the user to tape the advertisements using the row of functions 1320, as described earlier. Furthermore, the products screen frame 2900 provides the user with the option to purchase the desired product illustrated for example, by a product icon 2930, using a buy now button 2910.

If the user selects the internet banner 2620 (FIG. 26), the user station 105 automatically connects to the local DBA site 210 to a bookmarked web site or to the local DBA site 210 web site, in order to enable the user to access the internet or intranet.

Referring now to FIGS. 29, 30, 31, 32, 33 if the user selects the product icon 2830, the local DBA site 210 connects to, and displays on the user station 105 an enlarged view of the product 3000. In this illustration, the product 3000 is a standalone alarm clock/radio 3000 that includes all the features of the user station 105, as described herein.

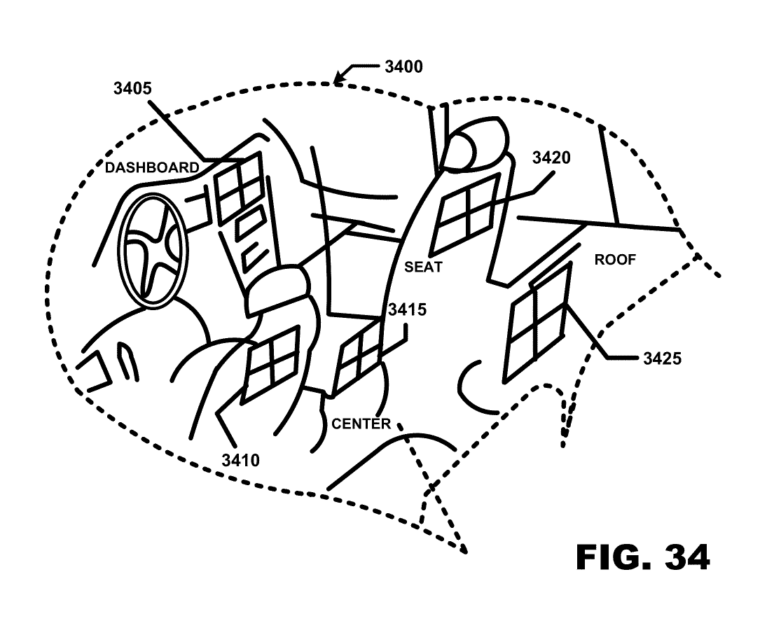

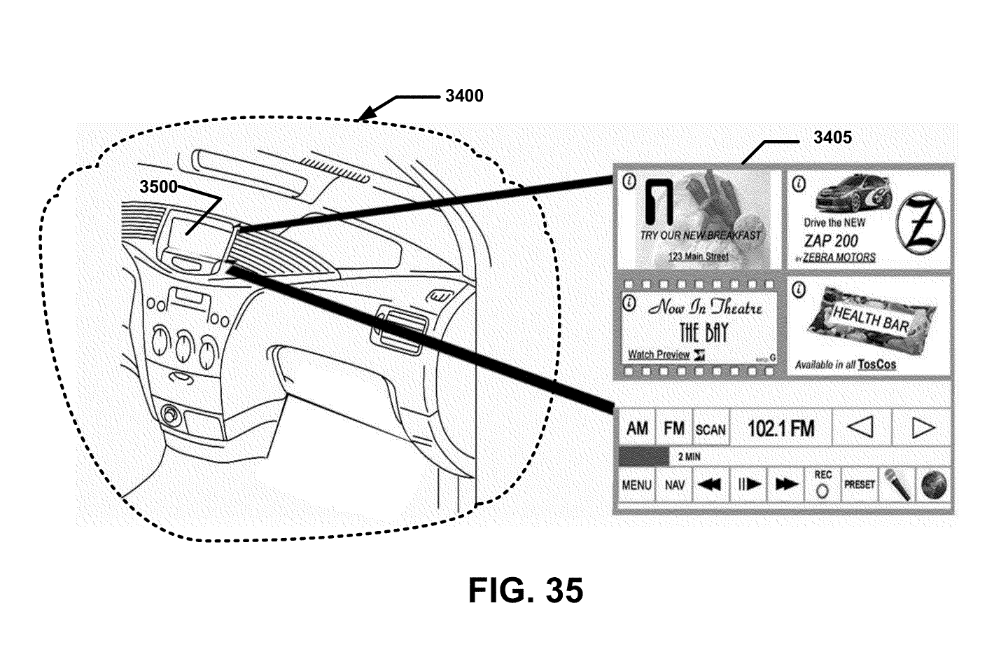

With reference to FIG. 34, it illustrates a vehicle 3400, such as a car, a plane, or a boat, with several user stations 3405, 3410, 3415, 3420, 3425, shown placed at various locations in the vehicle 3400. FIG. 35 illustrates an enlarged view of the user station 3405 which is positioned on the dashboard 3500 of the vehicle 3400.

The interactive radio network 100 is a novel, complete modern radio system that brings web interface advertising and phone applications to vehicle radios, mobiles, or stationary audio video equipment, in addition to being a web base shopping network. The interactive radio network 100 brings a new radio experience to cars and places of living. It allows users to take charge of their radios and to control various aspects of listening with added visual graphics. The interactive radio network 100 connects radio broadcast technology to mobile phones and other portable devices, and allows listening and viewing programs in a new and expanded format.

The interactive radio network 100 can also be added to an existing or conventional radio system and cellular phone, by adding an interactive radio network software or application, or by adding hardware. Alternatively, the interactive radio network can be connected using a wireless connection, such as Bluetooth or another wireless protocol. Ultimately, the interactive radio network 100 could be used in most households or places of business, replacing the conventional radio systems, and becoming a standard feature in modern vehicles.

By providing the users of the interactive radio network 100 with a multitude of choices, they will no longer feel overwhelmed with billboards that litter the roads and the desperate need to look and read, taking the risk of driving unsafely. All the user needs to do is to touch (or call out a ‘save screen’ command) the banner on the screen of his/her user station 105, in order to save the selection for later viewing.

Data such as location, price, function, demonstration video, menu, save, reservation, order, etc. can be obtained with a touch of a button or with simple voice instruction commands. The user will have his/her choice to decide whether to buy, book a reservation, watch a demonstration, know the location and directions, read or dial the phone number, in addition to other functions made simple and user friendly. The user may also complete a transaction using, for example, a safe credit account, or may buy directly from the source.

The users of the interactive radio network 100 will also take control of the radio stations they listen to, by seeing their broadcast schedule, record, pause and playback according to their needs. They can access International stations with a simple touch that takes them anywhere in the world and listen to broadcasts that would otherwise not be previously available in their geographical areas.

Another feature of the interactive radio network 100 is the ability to record conversation inside the car. This feature may be integrated with the main menu where it shows a microphone button 1328 (FIG. 13A) that activates the microphone 310 (FIG. 3) either via voice command or by pressing the microphone button 1328. Such a selection will cause an external recording mode screen frame 1390 to appear on the user station 105, and to provide the user with recording control buttons 1391, including a view recording history button or key 1392.

The selection of the view recording history button 1392 causes the user station 105 to display a new view recordings history frame 1394 (FIG. 13F) that shows a history 1395 of the recordings. Each entry, i.e., 1396, of the history 1395 provides the user with options, such as save to user's account 1397 or download to an attached storage device, via for example, a USB, firewire, etc. 1398. These options will enable the users to dispense with their laptop computers or portable mobile phones for the access of basic information.

The interactive radio network 100 enables distribution or transfer of the stored messages or advertisements to other users on a social network. The advent of hands free mobile phone laws also makes the interactive radio network 100 a safe way to continue operating the phone or text messaging, transporting and managing data to the user station 105.

The interactive radio network 100 can also download and play audio/videos banners or broadcast programs, for example, when the vehicle is stationery and safely parked. The interactive radio network 100 is provided with a voice command that makes it a portable search engine.

The local DBA site 210 of the interactive radio network 100 will not only serve as a listening tool to the users wishing to hear the various radio stations, but it will also act as a shopping network for the advertisers. Another added feature is that the interactive radio network 100 provides a news network that provides news coverage through radio or television. The interactive radio network 100 can also connect the live blogs and provides international users coverage.

The interactive radio network 100 including the local DBA site 210 provides a very high return per advertising dollar compared to other media. As a result, the interactive radio network 100 allows advertisers anywhere in the world, and at any time, to reach mobile audiences and to deliver a precise and clear message for goods or services rendered, and immediate ability to purchase the products or services.

The advertisers using the interactive radio network 100 can now focus on any geographical area worldwide, and post advertisements that are geared to a local market and to expand coverage in any language on a county, state, country, or even continent level. Advertisers will no longer have to incur the high cost of standard highway billboard signs. It allows them to post banner advertisements for a much longer period than the average highway billboards or street signs that passersby may or may not notice.

The local DBA site 210 is expected to reach a far larger audience compared than stationary billboard signs on today's roads. It can be present at all times and with no restrictions on any roads. It requires no permit and is not concerned with size, weight and height placed on sign construction by localities.

The local DBA site 210 provides wide access to information, allowing an advertiser a unique opportunity to deliver a concise and clear message to a widespread audience. The interactive radio network 100 provides the advertiser with the opportunity to load the local DBA site 210 with a refined message, video, audio, menu, reservation, direction, phone number, and other options that facilitates the consumption of a transaction or sale.

The advertisers of the interactive radio network 100 will also have the option to display, on the user station 105, a video commercial (message, graphics, etc.) that corresponds to the advertisement heard on a particular radio station. As a result, the video commercial and the audio advertisement can now be synchronized, using for example, the exemplary tabulated schedules illustrated in FIGS. 5, 9, and 10.

Another significant feature of the interactive radio network 100 is that a new advertiser will have a chance of exposure similar to that advertiser's competitors. In essence, the interactive radio network 100 advertisement creates an even playing field for the small business operator to compete and realize his/her dream.

The interactive radio network 100 collects and offers data relating to the user of the user stations 105, 110, such as the number of listeners to radio stations and programs, and the number of advertisements that are accessed, read, clicked, saved, and enabling product/service consumption. Such data will prove quite valuable to professional marketers, manufacturers, producers, and advertisers.

The shopping network of the interactive radio network 100 will also expand the markets for the advertisers using the interactive radio network 100.

A user can now access the interactive radio network 100 to browse and shop for different products and services (collectively referred to herein as “goods”). For example, the user can access the advertised goods by clicking on the front page showing the mock up monitor or screen frame, or by choosing different categories displayed on the website. The goods that are advertised and offered may or may not be part of the network broadcast. The user may regress in time and/or geographical location, to search for a particular advertisement/message seen on user station 105.

The user can access and read about the interactive radio network 100 on a page titled ‘About’ that spells out the idea, purpose, and philosophy behind the interactive radio network 100. The users and especially those users who are interested in acquiring a license to use the interactive radio network 100, to advertise their goods, will be able to access and contact the interactive radio network 100, and acquire the necessary personalized license.

For example, cellular telephone manufacturers can request or download a preliminary agreement to install the interactive radio network software on their cellular phones, which will enable their customers to benefit from the interactive radio network functions. The method of calculating fees paid to the interactive radio network for the licensed use of this network, will be explained to the users following the initial contact. The users must adhere to the policies set forth by the interactive radio network 100.

Car manufacturers and marketers can request or download a preliminary agreement, enabling them to install the interactive radio network software on their built-in radio systems that will enable their customers to benefit from the interactive radio network functions.

Telephone utilities, such as telephone companies may apply or request certain exclusive features such as coverage areas, priority to display, unique method of displaying on monitors or other features to be determined that will differ from standard features.

Radio stations that are broadcasting in analogue format, need to buy a license that allow their programs to be uploaded and displayed on the interactive radio network 100 in digital format, to the local DBA site 210 for the users to access. A third party advertiser contract will need to be filled out with fees paid to the interactive radio network 100. Radio stations need to buy the proper interactive radio network software and maintain it by periodically upgrading it. This software will allow them to upload video and/or audio clips for display on the user stations 105, 110. The broadcasting stations can decide on the desired areas of coverage, times, lengths of the advertisements, and various other functions.

Individual users of the interactive radio network 100, include for example, cellular phone owners, equipment or software owners in various forms, such as mobile or PC web access stationary or on WIFI, car radio owners wishing to access the interactive radio network functions, users wishing to upgrade when buying the add-on devices in wireless or direct wire connections to their existing radio system. Other users are able to make their existing system compatible with the interactive radio network, by purchasing a compatibility hardware and/or the software application.

Corporate and or individual advertisers may upload contents and buy one or more local DBA site 210 slots or blocks of slots to display their banners in various formats, such as JPEG, TIFF, or any other available or known format, load the proper information such as the ‘message’ and the coordinates for GPS use. They may elect to upload video and/or audio to the message. They may decide to tie into certain radio stations to schedule and display audio/video appearances simultaneously, during the ad broadcasted on the radio.

Corporate and/or individual users may include the address and telephone number on their advertisements in the local DBA site 210 blocks, the ability to make a reservation, or pay for goods and services directly or through a third party payment center or through a payment center controlled and operated by PayGio™, the interactive radio network direct payment center.

The advertisers may also choose to advertise on the interactive radio network 100 web site without being part of the interactive radio network 100.

The products page or screen frame 2810 (FIG. 28) enables the display of various products that are offered for purchase by the users. For example, the interactive radio network software on portable devices or PCs. This software will enable the users to benefit from the various features of the interactive radio network 100. The interactive radio network software for users and advertisers, and its related upgrades allows the users to play, upload advertisements, and remain current on all the interactive radio network 100 features.

The interactive radio network 100 add-on devices (e.g., monitors) will be available for purchase, for connection through hardwire, or they could be plugged into an existing or conventional radio. These add-on devices may be connected to a speaker access plug that is built in the vehicle or in the stand-alone radio or cellular phone, or any other equipment to allow the interactive radio network features to be displayed on the user stations 105, 110 or monitors.

The interactive radio network 100 add-on in a wireless or remote application can also be mounted near the car radio or on the cellular phone or near any equipment capable of displaying the interactive radio network 100.

The interactive radio network 100 offer a software or application that allows users to access and browse through various radio stations in any given area in the country or the world, and choose stations to save or hear instantly or play previously recorded sessions. This software allows recording on demand, storing, play back, fast forward, and replay features. This application allows the users to view, search saved messages and advertisements on the users' computers.

The interactive radio network 100 subscription allows users to maintain and upgrade various software on a flat fee basis paid monthly or annually. Users can access the various desired software and upgrades at any time for download.

The interactive radio network 100 also provides a users social club membership, pursuant to which a user can join a members' club, which allows them to share, chat, blog, and stay in touch with current events, with the ability to tie in to other social clubs, such as Facebook and Twitters. Users can post news on the interactive radio network's news network, entertainment, sports, and general articles. Members will be asked to pay a certain membership fee to the interactive radio network 100 on a monthly or annual basis.

The advertisers using the interactive radio network 100, such as radio stations, marketing companies, or individual firms, can become members of the interactive radio network 100 advertisers' club membership. The advertisers can advertise for services, such as special packaging prices for the development of the advertisements, maintenance and posting agreements with the interactive radio network users. The advertisers may post news, entertainment, sports, and general articles. Members may share information, chat, blog, and stay in touch with current events. Members will be asked to pay a certain membership fee to the interactive radio network 100 on a monthly or annual basis.

The interactive radio network 100 also provides a radio stations software that allows radio stations to buy slots on a time grid provided by the interactive radio network 100 on its web sites for their advertisers. The radio stations will need to log on the local DBA site 210 and enter a password and make payment arrangements depending on the size of the advertisements, the amount of memory required for the advertisements, the time and the frequency of appearance, and the length of each advertisement. This software works on multiple inputs by radio stations, i.e., digital, FM, or analogue. It also allows radio stations to choose signals and coverage area. Other functions for this software is to allow radio stations to synchronize video, audio, and graphics in the advertisements to simultaneously play them when the radio stations broadcast the original voice advertisements.

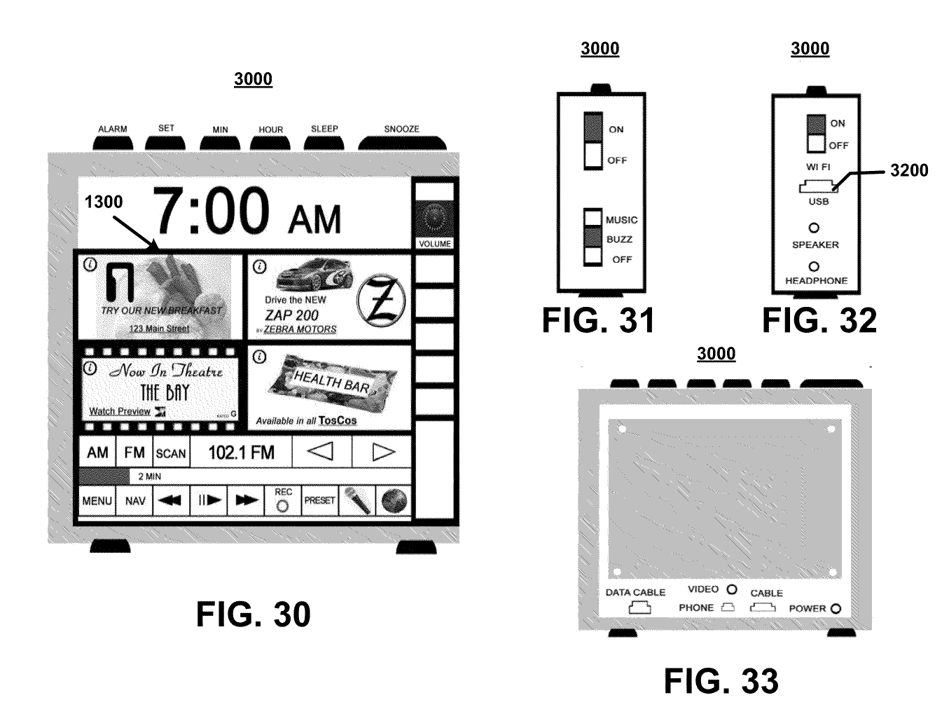

The interactive radio network 100 radio clock 3000 (FIG. 30) is an actual receiver that is sold separately and can be portable, mobile, or stationary. It has the monitor for viewing and has multiple functions to play DVDs and to download data. It is equipped with USB ports 3200 (FIG. 32) in addition to the other functions in any conventional radio adapted to receive digital, FM, or analogue signals. It may be upgraded to receive and process analogue and digital TV/satellite signals, and allows allow the user to listen and/or watch the broadcast schedules, and to record, pause, and to playback stored programs. The interactive radio network alarm/radio clock 3000 also possesses the features of a conventional alarm clock and can be placed near the bed or any other suitable location. It further includes all the features of user station 105, as described herein.

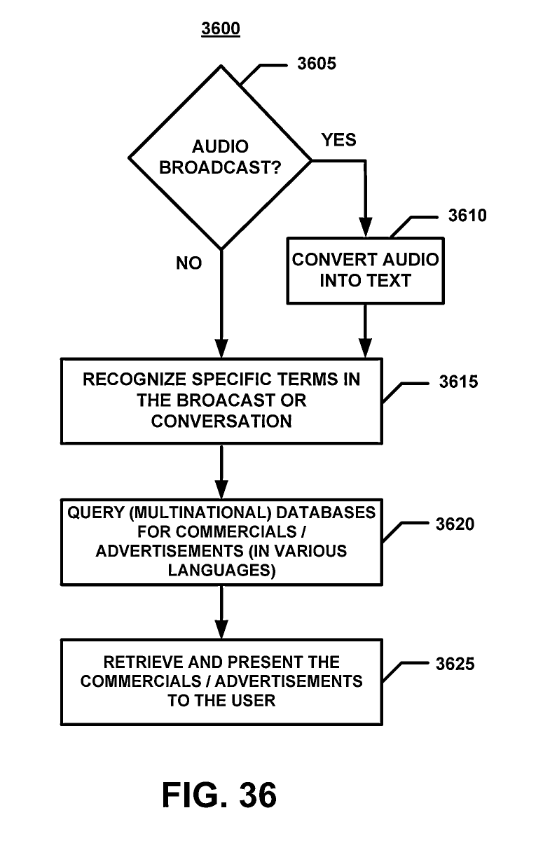

FIG. 36 is a flow chart illustrating an additional or optional plug-in, method, or service (collectively referred to herein as the plug-in 3600″) of the local DBA site 210 of FIG. 2. Although the plug-in 3600 is illustrated in FIG. 11B as being added to the operation of the present system following step 1135, it should be abundantly clear that the plug-in 3600 can be added (or introduced) at any other suitable step of the process 1100, either by the user, or the DBA site 210 with the user's legal permission.

The plug-in 3600 generally enables the interactive radio network 100 to perform and to expand its query by recognizing specific terms being broadcast. These terms could be found in the broadcast, whether textual or audible, or during a conversation (or communication, i.e., text messaging) that is carried out by the user over the user station 105. Additionally, the commercials could also include tags, flags, or keywords that are recognized and used by the plug-in 3600.

The plug-in (or method) 3600 starts at step 3605 by inquiring whether the broadcast (including the conversation) being monitored is an audio broadcast (or conversation). If it is, then the plug-in 3600 proceeds to step 3610 and converts the audio signals to text. The plug-in 3600 then proceeds to step 3615.

If the plug-in 3600 determines at decision step 3605 that the broadcast being monitored does not contain audio signals, then it proceeds to step 3615, where it recognizes specific terms (or keywords) in the broadcast, conversation, and the tags or keywords that are tagged or associated with the broadcast or conversation.

At step 3620, the plug-in 3600 uses the specific terms that have been recognized at step 3615 to query a database of advertisements and commercials that are either stored on a plurality of clouds, servers, etc., or communicated on the Internet or similar networks, in order to retrieve, generate, or reproduce, and to present relevant commercials and advertisements to the user, at step 3625.

According to still another embodiment, the plug-in 3600 is not limited to the English language. Rather, the plug-in 3600 can, at step 3620, translate the recognized specific terms into various languages, in order to broaden the query to multinational networks and databases, and to retrieve and to present to the user, a wider selection of international commercials and advertisements. The user has the option to select the international language (or languages) of choice.

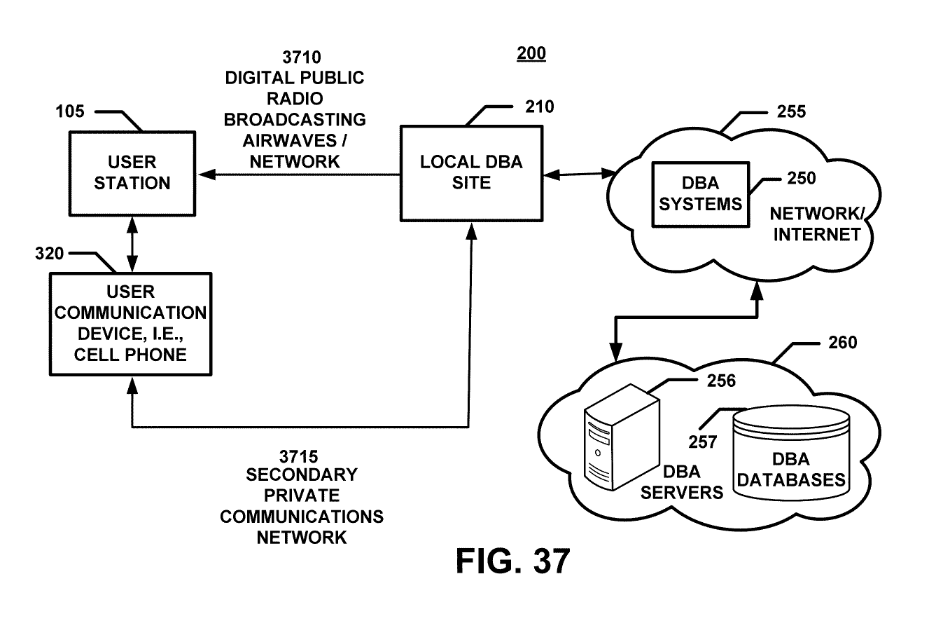

FIG. 37 summarizes and clarifies the concept of communication bifurcation between the user and the interactive radio network 100, as described earlier. FIG. 37 is a simplified schematic illustration of the digital broadcasting for advertisement (DBA) system 200 of FIGS. 1, 2, and 3, that shows the hybrid, bifurcated communication between the exemplary user station 105 and the local DBA site 210 over a primary channel 3710 that contains and carries the public digital public radio broadcast airwaves, and a secondary, user-initiated private communications network 3725 that carries the information in response to the user query or request for additional information (steps 1145, 1155, FIG. 11B). The secondary private communication network 3710 is separate from the primary digital public digital radio network 3715.

In one embodiment, the result of the user's query is transmitted from the local DBA site 210 to the user's communication device, such as a cellular phone or any other similar communication device, over the secondary private communications network 3715. The communication is then transmitted or tethered to the user station 105. In another embodiment, the user communication device can be functionally (i.e., by software) or physically combined with the user station 105.

As used herein, “Digital public broadcasting airwaves/network” 3710 includes without limitation, transmissions of digital public radio signals that are not under the control of the user. “Secondary private communications network” includes, without limitation a network capable of transmitting the user's queries to the DBA system 200, and of further transmitting additional information from the DBA system 200 to the user in a private or semi-private (i.e., a defined group of users) setting. It is also conceivable for the DBA system 200 to transmit, when appropriate, the information requested by the user over the digital public radio broadcasting airwaves, to the user, a group of users, or to the public in general, without interruption to the digital public radio broadcasting airwaves 3710, thus enabling dual, concurrent communications with the local DBA site 210.

It is to be understood that the specific embodiments of the invention that have been described are merely illustrative of certain application of the principle of the present invention. Numerous modifications may be made to the present system and method described herein without departing from the spirit and scope of the present invention. Moreover, while the present invention is described for illustration purpose only in relation to Internet communications, it should also be clear that the invention is applicable as well to documents and files shared electronically over any type of electronic or wireless network. It should also be clear that the present invention, including the applicable software application, could be integrated with available devices or systems, such as, for example only, Apple Computer, Inc.'s iPhones and iPods. Furthermore, although the examples described herein illustrate the visual radio advertisements as being broadcast or transmitted concurrently with the radio programs, it should be understood that the users may elect program the user stations 105 to show the advertisements exclusively, and to shut off the radio function, and vice versa, the users may elect to the exclusive enjoyment of the radio programs without the commercials.

What is claimed is:

1. A user station for providing interactivity to a public radio network that broadcasts a digital radio program, wherein a server selectively merges visual advertisements with the digital radio program at allotted time slots, and concurrently transmits the merged digital radio program and the visual advertisements to a plurality of users, the user station comprising:
a receiver for playing the digital radio program and for displaying the visual advertisements;
the receiver further including a means for enabling a user to select the digital radio program;
wherein, in response to a user selection of the digital radio program made on the receiver, the receiver automatically queries the server based on the user selection, over a separate network, without interruption to the digital radio program; and
wherein in further response to the user selection, the server retrieves additional data related to the selected digital radio program, and transmits the additional data to the receiver over the separate network, thus enabling a dual-channel communication of the user station with the server in order to achieve interactivity with the public radio network.

2. The user station of claim 1, wherein the server transmits the additional data to a user's mobile telephone.

3. The user station of claim 1, wherein the user station tethers at least one of the visual advertisement to a screen for display.

4. The user station of claim 1, wherein the user station tethers the digital radio broadcast program to a screen for display.

5. The user station of claim 1, wherein the separate network includes any one or more of: a nG communication network, a mobile telephone network, a satellite telephone communication network, a WIFI communication network, an Internet communication network, and an intranet communication network.

6. The user station of claim 1, wherein in response to the user selection, the receiver performs any one of more functions: saving, storing, deferred playing, deferred viewing, forwarding, reviewing, transferring, responding, fast forwarding, rewinding, retransmitting, routing, managing, downloading, processing, enabling an action in response to, and responding to any one or more of the selected digital radio broadcast program.

7. The user station of claim 1, wherein the user station selectively executes predefined instructions by automatically communicating with the server over the separate network, to post any one or more of:
an advertisement,
a response, and
a comment, on the server,
for selective distribution to other user stations, over the public radio network.

8. The user station of claim 1, wherein the user station automatically communicates with the server over the separate network, to become an advertiser for posting an advertisement over the public radio network.

9. The user station of claim 1, wherein the server includes a scheduler module for programming a schedule for allotted time slots, for the visual advertisements and the digital radio program.

10. The user station of claim 9, wherein the server includes an interface for selectively allowing a plurality of advertisers to access the server, in order to reserve desired time slots to place the visual advertisements.

11. The user station of claim 10, wherein the server includes a module for displaying, to a properly logged-in advertiser, a plurality of allotted slots that are available to the logged-in advertiser for the placement of the visual advertisements.

12. The user station of claim 11, wherein the server includes a module for displaying to the properly logged-in advertiser, a plurality of parameters for further selection of the allotted slots; and
wherein the plurality of parameters include any one or more of times, durations, lengths, and frequencies of the allotted slots that are available for the visual advertisements, as well as the programs to be concurrently broadcast with the available allotted slots.

13. The user station of claim 12, wherein the server includes a calculator for automatically calculating charges associated with a selection of the plurality of parameters for the available allotted slots; and
a module for automatically forwarding the calculated charges to the properly logged-in advertiser.

14. The user station of claim 1, wherein the server includes a module for selectively allowing a plurality of marketers to access the server, in order to collect metadata related to the visual advertisements and the digital radio program.

15. The user station of claim 11, wherein the server includes a module for automatically calculating charges associated with collected metadata; and
a module for automatically forwarding the calculated charges to the plurality of marketers.

16. A user station for providing interactivity to a public radio network that broadcasts a digital radio program, wherein a server selectively merges visual advertisements with the digital radio program at allotted time slots, and concurrently transmits the merged digital radio program and the visual advertisements to a plurality of users, the user station comprising:
a receiver for playing the digital radio program and for displaying the visual advertisements;
the receiver further including a means for enabling a user to select at least one of the visual advertisements;
wherein, in response to a user selection of said at least one of the visual advertisements made on the receiver, the receiver automatically queries the server based on the user selection, over a separate network, without interruption to the digital radio program; and
wherein in further response to the user selection, the server retrieves additional data related to the selected at least one of the visual advertisements, and transmits the additional data to the receiver over the separate network, thus enabling a dual-channel communication of the user station with the server in order to achieve interactivity with the public radio network.

17. The user station of claim 16, wherein in response to the user selection, the receiver performs any one of more functions: saving, storing, deferred playing, deferred viewing, forwarding, reviewing, transferring, responding, fast forwarding, rewinding, retransmitting, routing, managing, downloading, processing, enabling an action in response to, and responding to any one or more of the selected at least one of the visual advertisements.

18. The user station of claim 16, wherein the user station selectively executes predefined instructions by automatically communicating with the server over the separate network, to post any one or more of:
an advertisement, a response, and a comment, on the server, for selective distribution to other user stations, over the public radio network.

19. The user station of claim 16, wherein the user station automatically communicates with the server over the separate network, to become an advertiser for posting an advertisement over the public radio network.

20. The user station of claim 16, wherein the server includes a scheduler module for programming a schedule for allotted time slots, for the visual advertisements and the digital radio program.
